(19) United States
(12) Patent Application Publication
(10) Pub. No.: US 2022/0380943 A1
(43) Pub. Date: Dec. 1, 2022

(54) POLYMERIC FIBER MATERIALS FOR THERMAL AND MECHANICAL PROTECTION AND METHODS OF MAKING

(71) Applicant: President and Fellows of Harvard College, Cambridge, MA (US)

(72) Inventors: Grant Michael Gonzalez, Somerville, MA (US); John F. Zimmerman, Boston, MA (US); Kevin Kit Parker, Cambridge, MA (US)

(21) Appl. No.: 17/771,530

(22) PCT Filed: Oct. 30, 2020
(86) PCT No.: PCT/US2020/058379

§ 371 Date: Apr. 25, 2022

Related U.S. Application Data
(60) Provisional application No. 62/929,503, filed on Nov. 1, 2019.

(51) Int. Cl. D01F 6/60; D01D 5/06; D01D 5/18

(52) U.S. Cl. CPC D01F 6/605; D01D 5/06; D01D 5/18

(57) ABSTRACT

System, devices and methods for the fabrication of polymeric fibers, as well as resulting polymeric fibers, polymeric fiber materials and uses thereof are described. The polymeric fibers include poly(para-phenylene terephthalamide) (PPTA) fibers having an average fiber diameter in a range of 300 nm to 3 μm, and having an average Young's modulus in a range of 1 GPa to 100 GPa. Some materials including a plurality of the polymeric fibers have a thermal conductivity (k) in a range of 0.005 W/(m·K) to 10 W/(m·K) as measured perpendicular to a plane of the material.

### CROSS-REFERENCE TO RELATED APPLICATION

The present application claims the benefit of priority to U.S. Provisional Patent Application No. 62/929,503, filed Nov. 1, 2019, the entire contents of which are incorporated herein by reference.

### GOVERNMENT SUPPORT

This invention was made with Government support under 1420570 awarded by the National Science Foundation. The Government has certain rights in the invention.

### TECHNICAL FIELD

The present invention provides systems, devices and methods for the fabrication of polymeric fiber materials having relatively low thermal conductivity and sufficient Young's modulus to provide fragmentation protection.

### BACKGROUND OF THE INVENTION

Fibrous materials possess unique combinations of properties, such as pliability, toughness, and durability that make them an attractive material for various applications. Synthetic fiber production emerged in the 19th century and high-strength synthetic fibers such as Nylon and KEVLAR were commercialized in the 1930s and 1970s, respectively. Today, synthetic fibers are widely used to reinforce composite building materials, tires, sporting equipment, and armor. High porosity fibrous scaffolds are used for filtration, sensors, and catalysis as well as for tissue engineering and regenerative medicine. Because unique properties of fibrous materials derive from the high aspect ratios of fibers, recent efforts have focused on developing techniques for producing nanofibers with diameters less than 1 μm. Examples of commonly used nanofiber production techniques include self-assembly, phase separation, template synthesis, touch spinning, magnetospinning, fluidic spinning, and electrospinning (ES).

ES is a popular and versatile method for manufacturing polymer nanofibers. However, producing nanofibers using highly charged polymers jets can be challenging due to electric field interference. For instance, ES of pure alginate or DNA dissolved in water, even into a precipitation bath, is hampered by interference from their polyelectrolyte backbones. Additionally, some non-charged polymers cannot be spun using common volatile solvents such as hexafluoroisopropanol (HFIP), requiring additives to facilitate fiber formation. For instance, the addition of salts has been critical to spin meta-aramid dopes. Moreover, polymer solution viscosity and solvent evaporation rate must be carefully balanced in order to overcome instabilities caused by surface tension. Unless these spinning conditions are correctly balanced, the dominance of surface tension can create a high-energy Raleigh-Plateau instability that forces the polymer-jet to bead or break apart.

People operating under extreme environments often require simultaneous protection from multiple threats. For example, the extreme environment of outer space offers multiple threats that require personal protection. To provide protection from space-debris and solar radiation, Apollo Era astronauts utilized moon suits comprised of 21 individual layers and multiple material layers including KEVLAR, a poly(para-phenylene terephthalamide) material from DuPont (CAS Registry No. 24938-64-5) and NOMEX a poly (meta-phenylene isophthalamide) material from DuPont (CAS Registry No. 333-86-4). Advancements in material design have reduced the number of layers from 21 to 13 in the Extravehicular Mobility Unit spacesuit but both KEVLAR and NOMEX are again required. Like astronauts, bomb disposal personnel in law enforcement and the military wear suits comprised of both these materials to protect against the environmental threats generated during a bomb explosion. These suits are required to provide concurrent thermal and fragmentation resistance. Competing environmental factors have necessitated the use of multiple layers, with each contributing distinct material properties to the overall composite performance without sacrificing flexibility. For example, one way this had been accomplished is by interweaving several layers of continuous aramid-based fibers, such as KEVLAR and NOMEX into a single, flexible garment. KEVLAR for example, is a para-aramid material that exhibits high mechanical ultimate tensile strength and modulus, providing ballistic and fragmentation protection. On the other hand, NOMEX is a meta-aramid material that provides minimal ballistic protection, but offers high thermal resistance, insulating astronauts from the extreme temperature differentials in space. While each material serves independently as a high-performance fiber, manufacturing protective equipment, clothing or textiles from a single multifunctional material instead could reduce the overall weight and complexity of the equipment, clothing or textile. However, thermal and mechanical protection can be difficult to achieve in a single multifunctional material, as materials traditionally trade-off between these two properties, as a result of structure-function relationships. For example, high-strength materials are generally highly crystalline with a low concentration of defects. However, these highly ordered domains, which offer rigid, simultaneous bond deformation against mechanical insult, also offer rapid phonon and heat transport. This transition between crystalline and amorphous phases creates a fundamental trade-off between thermal and mechanical protection that is difficult to overcome.

To achieve these simultaneous properties, multifunctional materials that are engineered to alter this basic structure-function relationship from the bond-to-nano-macro-scales are needed to achieve the next generation of high-performance fibers.

Combining these layer properties in a single material could improve the performance of personal protective equipment while decreasing both the overall weight and manufacturing complexity. However, synthesizing multifunctional material can be challenging as high-performance fibers often exhibit a trade-off between material properties. For example, the poly(para-phenylene terephthalamide) (PPTA) fiber-based material sold as KEVLAR for mechanical protection has, relatively high thermal conductivity, but is a poor thermal insulator. In contrast, textile materials that provide thermal resistance, such as NOMEX, do not have sufficient Young's modulus to provide mechanical protection.

Accordingly, there is a need in the art for improved materials for materials that can provide both mechanical protection and thermal protection.

### SUMMARY OF THE INVENTION

In some embodiments, the present invention provides systems, devices and methods for the fabrication of materials including para-aramid polymeric fibers (e.g., PPTA fibers) and para-aramid polymeric fiber sheets (hereafter “pAFS”) (e.g., sheets of PPTA fibers) having a micron, submicron or nanometer scale diameter that exhibits a beneficial combination of a relatively high Young's modulus to provide ballistic or fragmentation protection and a relatively low thermal conductivity to provide thermal insulation, as well fabrics, clothing, and articles made from such materials. In some embodiments, the present invention also provides methods for forming para-aramid polymeric fibers (e.g., PPTA fibers) having relatively small diameters and relatively large length to diameter aspect ratios that have a desirable microstructure. Although some embodiments are described herein with respect to PPTA fibers, one of ordinary skill in the art will recognize that the invention is not limited to PPTA and other types of para-aramid polymers, other types of rigid rod polymers, or some co-polymers with limited order may be employed instead of, or in addition to PPTA. Another type of para-aramid polymer that could be employed in some embodiments is poly(para-benzamide). In some embodiments, other rigid rod polymers could be employed, such as. Examples include, but are not limited to, one or more of CAS Registry Nos. 24991-08-0, 24938-64-5, 27307-20-6, 26402-76-6, 28779-61-5, 27252-16-0, 65749-45-3, 37357-28-1, 26402-76-6, 51257-61-7, 31801-22-6, 65749-46-4, 65761-30-0, 65749-48-6, 65749-49-7, and 52270-04-9. In some embodiments, some co-polymers with limited order could be employed. Examples include, but are not limitation to, one or both of CAS Registry Nos. 29153-47-7, and 65749-50-0.

In accordance with some embodiments, a material includes a plurality of polymeric fibers formed, at least in part, from a para-aramid polymer (e.g., PPTA). Fibers formed, at least in part from a para-aramid polymer may be referred to herein as para-aramid fibers. Fibers formed, at least in part, from PPTA may be referred to as PPTA fibers herein.

In some embodiments, the plurality of para-aramid fibers (e.g., PPTA fibers) may have an average fiber diameter in a range of 300 nm to 3 μm. In some embodiments, the average fiber diameter is in a range of 400 nm to 2.5 μm. In some embodiments, the average fiber diameter is in a range of 400 nm to 2.0 μm. In some embodiments, the average fiber diameter in a range of 400 nm to 1.5 μm. In some embodiments, the average fiber diameter in a range of 400 nm to 1.0 μm.

In some embodiments, the plurality of para-aramid fibers (e.g., PPTA fibers) may have an average Young's modulus, as measured with respect to a longitudinal axis of the fiber, in a range of 1 GPa to 200 GPa. In some embodiments, the plurality of para-aramid fibers (e.g., PPTA fibers) may have an average Young's modulus, as measured with respect to a longitudinal axis of the fiber, in a range of 1 GPa to 130 GPa. In some embodiments, the plurality of para-aramid fibers (e.g., PPTA fibers) may have an average Young's modulus, as measured with respect to a longitudinal axis of the fiber, in a range of 1 GPa to 100 GPa. In some embodiments, the plurality of para-aramid fibers (e.g., PPTA fibers) may have an average Young's modulus, as measured with respect to a longitudinal axis of the fiber, in a range of 1 GPa to 50 GPa. In some embodiments, the plurality of para-aramid fibers (e.g., PPTA fibers) may have an average Young's modulus, as measured with respect to a longitudinal axis of the fiber, in a range of 1 GPa to 30 GPa. In some embodiments, the plurality of para-aramid fibers (e.g., PPTA fibers) may have an average Young's modulus, as measured with respect to a longitudinal axis of the fiber, in a range of 1 GPa to 25 GPa. In some embodiments, the plurality of para-aramid fibers (e.g., PPTA fibers) may have an average Young's modulus, as measured with respect to a longitudinal axis of the fiber, in a range of 1.5 GPa to 5.5 GPa. In some embodiments, the plurality of para-aramid fibers (e.g., PPTA fibers) may have an average Young's modulus, as measured with respect to a longitudinal axis of the fiber, greater than 1 GPa. In some embodiments, the plurality of para-aramid fibers (e.g., PPTA fibers) may have an average Young's modulus, as measured with respect to a longitudinal axis of the fiber, greater than 10 GPa.

In some embodiments, the plurality of para-aramid fibers (e.g., PPTA fibers) of the material may have a Young's modulus in any of the ranges described herein in combination with a thermal conductivity (k) of the material being in a range of 0.005 W/(m·K) to 10 W/(m·K) as measured normal to a surface of the material and perpendicular to the orientation direction of the at least some of the fibers. In some embodiments, the plurality of para-aramid fibers (e.g., PPTA fibers) of the material may have a Young's modulus in any of the ranges described herein in combination with a thermal conductivity (k) of the material being in a range of 0.01 W/(m·K) to 10 W/(m·K) as measured normal to a surface of the material and perpendicular to the orientation direction of the at least some of the fibers. In some embodiments, the plurality of para-aramid fibers (e.g., PPTA fibers) of the material may have a Young's modulus in any of the ranges described herein in combination with a thermal conductivity (k) of the material being in a range of 0.01 W/(m·K) to 3.0 W/(m·K) as measured normal to a surface of the material and perpendicular to the orientation direction of the at least some of the fibers.

In some embodiments, the material may have a volume density in a range of 0.001 g/cm³ to 0.5 g/cm³. In some embodiments, the material may have a volume density is in a range of 0.01 g/cm³ to 0.5 g/cm³. In some embodiments, the material may have a volume density is in a range of 0.05 g/cm³ to 0.2 g/cm³.

In some embodiments, the material also includes a polymer disposed between fibers in the plurality of PPTA fibers. In some embodiments, the polymer comprises one or more of polyurethane, a hydrogel, and polyvinyl butyral. In some embodiments, the material further comprises phenolic resin.

In some embodiments, the material is a nonwoven material.

Some embodiments may include a garment or item of protective clothing including any of the materials described herein. In some embodiments, the garment or item of protective clothing provides fragmentation protection, fragmentation resistance, ballistic protection, or ballistic resistance for at least a portion of a body.

Some embodiments provide a layered material including a first layer, a second layer including any of the materials described herein comprising para-aramid or PPTA, and a third layer, with the second layer disposed between the first layer and the third layer. In some embodiments, the first layer includes a material different than the material of the second layer and the third layer includes a material different than the material of the second layer. In some embodiments, the first layer is a woven material, the third layer is a woven material, or both are woven materials. In some embodiments, the layered material includes one or more additional nonwoven layers of material comprising para-aramid or PPTA fibers.

Some embodiments may include a garment for providing fragmentation or ballistic protection to a portion of a body, the garment including any of the layered materials described herein. In some embodiments, the garment is at least a portion of a flight suit or a space suit. In some embodiments, the layered material may be fabricated into a garment (e.g., flight suit, space suit, vest). The garment may be configured to, in part, reduce (or protect) the user from the impact of explosions and fragmentation (e.g., a military vest).

In accordance with another exemplary embodiment, a method is provided for fabricating one or more polymeric fibers including a para-aramid polymer (e.g., PPTA) using an exemplary fiber formation device. The method may include providing a solution including the para-aramid polymer (e.g., PPTA) and sulfuric acid, or including the para-aramid polymer (e.g., PPTA), dimethylsulfoxide (DSMO), and potassium hydroxide (KOH). The method includes rotating a reservoir holding the solution about an axis of rotation to cause ejection of the solution in one or more jets from one or more orifices of the reservoir, and collecting the one or more jets of the solution in a precipitation bath having a temperature below ambient temperature in which the para-aramid polymer (e.g., PPTA) in the one or more jets precipitates to form one or more para-aramid (e.g., PPTA) fibers each having a diameter in a range of 400 nm to 2 μm.

In some embodiments, the precipitation bath has a temperature in a range of 1° C. to 5° C. In some embodiments, the precipitation bath has a temperature in a range of 1° C. to 3° C.

In some embodiments, the weight % of PPTA in the solution may be in a range of 0.1 wt % to 2.5 wt %. In some embodiments, the weight % of PPTA in the solution may be in a range of 0.3 wt % to 1.5 wt %. In some embodiments, the weight % of PPTA in the solution may be in a range of 0.5 wt % to 1.0 wt %.

In some embodiments, employing sulfuric acid in the solution, the sulfuric acid is in the range of 80% to 99% by weight in the solution.

In some embodiments employing DMSO in the spinning solution, the DMSO in the solution is the range of 92% to 99.8% by weight. In some embodiments employing KOH in the spinning solution, the KOH in the solution is in the range of 0.1% to 4% by weight.

In some embodiments, the reservoir may be rotated at a speed in a range of 3 kRPM to 45 kRPM during ejection of the one or more jets.

In some embodiments, the average fiber diameter is in a range of 400 nm to 2.5 μm. In some embodiments, the average fiber diameter is in a range of 400 nm to 2.0 μm. In some embodiments, the average fiber diameter in a range of 400 nm to 1.5 μm. In some embodiments, the average fiber diameter in a range of 400 nm to 1.0 μm.

In some embodiments, one or more resulting para-aramid (e.g., PPTA) fibers may each have a diameter in a range of 300 nm to 3 μm. In some embodiments, the resulting fibers may have an average fiber diameter in a range of 300 nm to 3 μm. In some embodiments, the resulting fibers may have an average fiber diameter is in a range of 400 nm to 2.5 μm. In some embodiments, the resulting fibers may have an average fiber diameter is in a range of 400 nm to 2.0 μm. In some embodiments, the resulting fibers may have an average fiber diameter in a range of 400 nm to 1.5 μm. In some embodiments, the resulting fibers may have an average fiber diameter in a range of 400 nm to 1.0 μm.

In some embodiments, sodium hydroxide may be added to the precipitation bath during collection of the one or more jets. In some embodiments, the precipitation bath may be stirred during ejection of the one or more jets. In some embodiments, the formed one or more PPTA fibers may be collected on a rotating collector that also stirs the precipitation bath.

In one or more embodiments of this disclosure, the ejected one or more jets may travel through an air gap between the rotating reservoir and a surface of the precipitation bath before being collected in the precipitation bath. In some embodiments, the air gap may have a width in the range of 2 cm to 10 cm. In some embodiments, the air gap may have a width of 2 cm to 6 cm.

In accordance with another exemplary embodiment, a composite material may include: a plurality of PPTA fibers having an average fiber diameter in a range of 300 nm to 2 μm and each having a length to diameter aspect ratio of greater than 1000 to 1; and a second polymer. In some embodiments, the average fiber diameter is in a range of 300 nm to 1.5 μm. In some embodiments, the average fiber diameter is in a range of 400 nm to 2.0 μm. In some embodiments, the average fiber diameter in a range of 400 nm to 1.5 μm. In some embodiments, the average fiber diameter in a range of 400 nm to 1.0 μm. In some embodiments, the average fiber diameter is in a range of 1 μm to 1.5 μm.

In some embodiments, the length to diameter aspect ratio is greater than 10,000 to 1. In some embodiments, the length to diameter aspect ratio is greater than 100,000 to 1. In some embodiments, the length to diameter aspect ratio is greater than 1,000,000 to 1. In some embodiments, the aspect ratio is in a range of 1000 to 1 and 100,0000,000 to 1. In some embodiments, the aspect ratio is in a range of 1000 to 1 and 10,000,000 to 1. In some embodiments, the aspect ratio is in a range of 10,000 to 1 and 10,000,000 to 1. In some embodiments, the aspect ratio is in a range of 10,000 to 1 and 1,000,000 to 1. In some embodiments, the aspect ratio is in a range of 100,000 to 1 and 10,000,000 to 1. In some embodiments, the aspect ratio is in a range of 100,000 to 1 and 1,000,000 to 1.

In some embodiments, the second polymer includes polyurethane. In some embodiments, the second polymer may include a hydrogel. In some embodiments, the second polymer includes polyvinyl butyral. In some embodiments, the composite material includes phenolic resin.

Other features and advantages of the invention will be apparent from the following detailed description and claims.

### BRIEF DESCRIPTION OF THE DRAWINGS

FIG. 1A schematically depicts an immersion Rotary Jet-Spinning System (iRJS) that can be used to form PPTA fibers in accordance with some embodiments.

FIG. 1B schematically depicts shear forces during jet elongation and polymer extension aligning polymer chains during formation of the PPTA fibers in accordance with some embodiments.

FIG. 1C schematically depicts streamlines of a vortex pull and fiber collection on a combined rotating collector/stirrer that is also used to stir the precipitation bath in accordance with some embodiments.

FIG. 1D is an image of fiber collection on a combined rotating collector/stirrer that is also used to stir the precipitation bath in accordance with some embodiments.

FIG. 1E is an image of resulting fibers that were collected on the combined rotating collector/stirrer in accordance with some embodiments.

FIG. 1F is an image of resulting fibers that were collected on a removable sleeve portion of the combined rotating collector/stirrer after separation from the stirrer portion in accordance with some embodiments.

FIG. 2A is an image of polymer sheets fabricated from synthetic PPTA after 30 s of spinning in accordance with some embodiments. These bulk sheets are comprised of small diameter fibers including nanofibers (scale bar=40 m)

FIG. 2B is a scanning electron microscope (SEM) image of the fibers in the sheet of FIG. 2A (scale bar=40 μm).

FIG. 2C is an SEM image of a single fiber in the sheet showing the fiber diameter to be less than 1 μm (scale bar=1 μm).

FIG. 3A schematically depicts a conventional non-immersion RJS system relying on a volatile solvent to spin small diameter fibers and the Raleigh—Plateau instability causing beading.

FIG. 3B is an SEM image of resulting fibers showing the beading (scale bar=20 μm).

FIG. 3C is a higher resolution image of resulting fibers showing the beading (scale bar=5 μm).

FIG. 4A schematically depicts the iRJS spinning process that reduces surface tension in the jets due to the precipitating bath, delaying Raleigh—Plateau instability to produce bead-free fibers.

FIG. 4B is an SEM image of resulting fibers from the iRJS spinning process (scale bar=20 μm).

FIG. 4C is a higher resolution image of the resulting fibers (scale bar=5 μm).

FIG. 5A is an Energy Dispersive X-Ray Spectroscopy (EDS) graph showing the atomistic components of the resulting PPTA fiber sheets, detecting carbon, hydrogen peaks, and sulfur peaks for unwashed PPTA fiber sheets and only carbon and hydrogen peaks for washed samples, confirming that residual sulfuric acid is removed from the formed fiber sheets by a post-spinning wash process.

FIG. 5B is a ring of spun fiber sheet material after removal from the collector.

FIG. 5C is an SEM image of the sheet of FIG. 5B (scale bar=20 μm).

FIG. 5D is a graph of average fiber diameter versus spinning speed showing that the fibers having an average diameter dependent on spinning speed.

FIG. 5E is a graph of average fiber diameter versus concentration of PPTA in the spinning solution showing that the fibers have an average diameter dependent on concentration.

FIG. 6A is an image of a uniaxial tensile testing apparatus for testing the resulting fiber sheets.

FIG. 6B is an image of the uniaxial tensile testing of the fiber sheets showing the direction of applied stress.

FIG. 6C is a graph of Young's modulus versus concentration of PPTA in the spinning solution showing a dependence of Young's modulus of the resulting fiber sheets on the concentration of the spinning solution used to form the fibers.

FIG. 6D is a graph of ultimate tensile stress versus concentration for the resulting fiber sheets.

FIG. 6E is a graph of toughness versus concentration for the resulting fiber sheets.

FIG. 7 includes real space transmission electron microscope (TEM) images (scale bars=100 nm), corresponding reciprocal space reciprocal space diffraction images (scale bars=5 nm⁻¹), and corresponding dark field images of resulting fibers spun from solutions having different concentrations of PPTA.

FIG. 8A includes TEM Images of resulting PPTA fibers spun from 3% polymer concentration (w/v %) solutions for both real space (scale bars=100 nm) and reciprocal space (scale bars=4 nm⁻¹) showing diffraction.

FIG. 8B includes TEM Images of resulting PPTA fibers spun from 10% polymer concentration (w/v %) solutions for both real space (scale bars=100 nm) and reciprocal space (scale bars=4 nm⁻¹) showing diffraction.

FIG. 9A is a graph of Raman spectra of commercial Kevlar microfibers, a cast film, and a spun fiber sheet for comparison.

FIG. 9B is a graph of Raman spectra of spun fiber sheets produced from 3%, 5%, 10% polymer concentration spinning solution.

FIG. 10A is a graph of a Raman spectrum analysis of a PPTA fiber sheet spun from a 10% concentration solution (10% PPTA fiber sheet), a comparison KEVLAR 29 material, and a cast sheet focusing on the 1640-1680 Amide I region of the samples including the crystalline 1648 cm-1 and amorphous 1654 cm-1 regions to provide an approximation of crystallinity.

FIG. 10B is a graph showing the peak determinations for KEVLAR 29.

FIG. 10C is a graph showing the peak determinations for the 10% PPTA fiber sheet.

FIG. 10D is a graph showing the peak determinations for the cast film.

FIG. 10E is a graph of the ratios of the area of the crystalline peak to the total area of the Amide I providing an approximation of crystallinity. Cast film and commercial fibers crystallinity values agreed with literature values. In addition, the full width half max (FWHM) of the sheets were narrower on average than the cast film indicating less variability between bonds and therefore more ordered structure (n=3).

FIG. 11A is a graph of Fourier Transform Infrared Spectroscopy (FT-IR) spectra of the 10% PPTA fiber sheets (36), the KEVLAR 29 (32) material and the cast film (34) demonstrating that the 10% PPTA fiber sheets PPTA and commercial PPTA microfibers reveal similar spectrum peaks and therefore the same types of bonds and that the chemistry of the polymer is not disrupted during fabrication with the cast film spectrum presented for an amorphous control. For all samples, the characteristic Amide I at 1648 cm-1, Amide II at 1540 cm-1, and C-C ring stretch at 1610 cm-1 are present.

FIG. 11B is a graph of FT-IR spectra of the 10% PPTA fiber sheets, the 5% fiber sheets, and the 10% fiber sheets showing similar peaks but not significant differences between the samples. Linear baseline with points at 600, 1050, 1750, 2800 cm′ was applied to correct for background noise (n=3 production runs)

FIG. 12A is an image of a scaled iRJS precipitation based fiber platform that produced larger samples for fragmentation testing and large scale testing of materials. A continuous fiber yarn system was built on the left of the glovebox and a non-woven system was built on the right of the glovebox. Both systems required the individual components including continuous, top loading reservoirs and scaled collection schemes.

FIG. 12B schematically depicts continuous reservoir loading and continuous fiber production in the scaled system. The iRJS uses a motor to accelerate a polymer solution out of a rotating reservoir, though an air gap, and into a precipitating vortex bath. Upon hitting the bath, the polymer dope precipitates into the fiber and the vortex bath pulls the fiber onto a rotating collector.

FIG. 12C schematically depicts a side view of the spinning process.

FIG. 12D is an image of the mixer and resulting precipitation bath vortex during spinning.

FIG. 12E is an image of a simulation of the forces on the reservoir during spinning used for designing the continuous top loading reservoir to have an acceptable safety factor at spin speeds of up to 45 k RPM.

FIG. 12F is an image of the continuous top loading Hasetlloy C276 reservoir employed to spin PPTA-sulfuric acid solutions.

FIG. 12F is an image of a spunpAFS.

FIG. 13A includes images of (PPTA-H₂SO₄) solutions having different concentrations of PPTA i) at rest, and ii) relaxing 30 s after being flipped, iii) an image of a rheometer with a cone geometry, and iv) an image of a solvent trap used to measure the rheological properties of the solutions (scale bars=8 mm).

FIG. 13B includes i) a schematic illustrating rheological properties important during jet initiation and graphs of data relating ii) viscosity to the shear rate and iii) normal stress to the shear rate for 2% PPTA solutions, 1% PPTA solutions and 0.5% PPTA solutions.

FIG. 13C includes i) a schematic illustrating rheological properties important during jet extension, specifically tan(δ) (i.e., the ratio of viscosity to elasticity)>1 at 83 Hz over any strain and temperature, and graphs of data relating ii) tan(δ) to the strain, and iii) tan(δ) to the temperature.

FIG. 13D includes i) a schematic illustrating rheological properties important during jet solidification, specifically tan(δ) (i.e., the ratio of viscosity to elasticity)<1 at 5 Hz over any strain and temperature, and graphs of data relating ii) tan(δ) to the strain, and iii) tan(δ) to the temperature.

FIG. 13E includes images of i) a porous, continuous pAFS having an area of 10 cm by 30 cm formed using a 1% solution that is viscous dominant at 80° C. during spinning and elastic dominant at 5° C. during fiber solidification, ii) a 10 cm by 10 cm testing sample cut from the pAFS, iii) an SEM micrograph of the sample (scale bar=20 μm), iv) and iv) a plot of fiber diameter distributions for samples from three different production runs (n=3).

FIG. 14A includes i) XRD spectra of commercial TWARON fiber sheets and produced para-aramid (e.g., PPTA) fiber sheets and ii) polarized Raman spectra of commercial TWARON fibers and produced para-aramid (e.g., PPTA) fibers (representative curve for n=3).

FIG. 14B includes images of i) uniaxial mechanical testing of fibers until break performed by pulling on a fiber gripped to the machine by a ii) frame to produce data yielding graphs of iii) representative stress-strain curves and iv) Young's Modulus, ultimate tensile stress, and elongation to break values (n=8), and images of a representative broken v) TWARON (scale bar=10 μm) and vi) pAF (Scale bar=1 μm). Box Plots: middle line indicates the median, the upper and lower box boundaries indicate the Q₇₅ and Q₂₅ respectively, and the top and bottom whisker lines indicates M±1.5IQR.

FIG. 15A includes i) a schematic and ii) an image of a system for measuring mechanical protection against fragmentation impact (scale bar=0.5 m, as well as iii) an image of fragment simulating projectile (FSP) used for testing (scale bar=2 mm). Mechanical protection against fragmentation impact testing was measured using the FSP accelerated via a controllable helium gas pressure toward a sample material. The velocity of projectile hitting and leaving the sample was measured using light gates. These velocities were used to calculate the V₅₀ protection value of the samples.

FIG. 15B includes images of test samples including control TWARON and pAFS before testing, after testing with a partial penetration, and complete penetration, with arrows indicate energy wave propagation (scale bars=2 cm). C) Ballistic testing was performed to see if the sheets provided ballistic protection.

FIG. 15C includes plots and a graph of results of ballistic testing on samples. Ballistic testing was performed to see if the sheets provided ballistic protection: i) 2 layers of TWARON were used to sandwich 1, 2, or 3 layers of pAFS; ii) 2 layers pAFS were placed in front, in middle, or behind, 2 layers of TWARON to test if the ballistic protection was dependent on position. “Front,” “middle” and “back” refer to the position of the pAFS layers in relation to the TWARON layers when facing the projectile. Each pAFS layer was 10 cm by 10 cm and weighed ˜1.7 g. Two layers of each material were used in cross-plied configuration, resulting in 4 total layers for each test. (n=4, * signifies a p<0.05). For each plot, a schematic of the tested samples is presented: darker gray represents TWARON layer and lighter gray represents a pAFS layer. When two box plots are plotted on the same x axis position, the TWARON-pAFS construct is represented. Box Plots: middle line indicates the median, the upper and lower box boundaries indicate the Q75 and Q25 respectively, and the top and bottom whisker lines indicates M±1.5IQR. iii) Normalized V₅₀ data with the predicted ballistic performance based on fiber mechanic scaling law U^{1/3}, area density of the samples, the area of the projectile, and the mass of the projectile (lines are plotted for visual aid).

FIG. 16A is an image of a commercial woven para-aramid material that may allow for puncture between individual woven pleats.

FIG. 16B is an image of a pAFS showing smaller diameter fibers and the non-woven nature, which may provide greater puncture resistance than that provided by the commercial woven para-aramid material in some embodiments.

FIG. 17A schematically depicts a setup for testing heat conductivity including a hot plate, a sample, and temperature probes used to measure the temperature on both side of the sample.

FIG. 17B is an image of the setup of 17A.

FIG. 17C is a graph of temperature as a function of heating time for the heat source, a TWARON sheet and a pAFS sheet (representative curves for n=minimum 3, filled area represents mean±standard error of the mean (SEM)).

FIG. 17D schematically depicts dimensions for a simulation of heat transfer from a heat source through a 5 cm thick air gap and a 1.75 cm thick layer of the pAFS insulator, and into a 2 cm thick heat sink.

FIG. 17E includes images of simulated temperature and heat transfer over time for the setup in FIG. 17D.

FIG. 17F includes images of simulated temperature and heat transfer for the setup in FIG. 17D with no insulating layer at t=0 minutes and at t=17 minutes for comparison.

FIG. 17G includes images of simulated temperature and heat transfer for the setup in FIG. 17D with a 1.75 cm thick TWARON insulating layer at t=0 minutes and at t=17 minutes for comparison.

FIG. 17H includes images of simulated temperature and heat transfer for the setup in FIG. 17D including the 1.75 cm thick pAFS insulating layer at t=0 minutes and at t=17 minutes.

FIG. 17I includes images of simulated temperature and heat transfer for the setup in FIG. 17D except with air only (left column), with a 0.1 cm thick TWARON insulating layer (middle column), and with a 0.1 cm thick pAFS insulating layer (right column) from t=0 second to t=1800 seconds.

FIG. 17J includes images of simulated temperature and heat transfer through a 3 cm air gap from t=0 second to t=1800 seconds.

FIG. 18A includes images of flame testing with no protective layer between a gelatin astronaut model (GAM) and a blow torch showing that the GAM began to melt within 5 minutes.

FIG. 18B includes images of flame testing with a TWARON protective layer between the GAM and the blow torch showing that the GAM began to melt within 17 minutes.

FIG. 18C includes images of flame testing with a TWARON protective layer between the GAM and the blow torch showing that the GAM did not begin to melt even at 35 minutes of exposure.

FIG. 19A includes a graph of die swelling for various orifice diameters.

FIG. 19B includes a graph of resulting fiber diameters for various orifice diameters.

### DETAILED DESCRIPTION

In the following description, it is understood that terms such as “top”, “bottom”, “middle”, “outward”, “inward”, and the like are words of convenience and are not to be construed as limiting terms. Reference will now be made in detail to embodiments of the disclosure, which are illustrated in the accompanying figures and examples. Referring to the drawings in general, it will be understood that the illustrations are for the purpose of describing particular embodiments of the disclosure and are not intended to limit the same.

Whenever a particular embodiment of the disclosure is said to comprise or consist of at least one element of a group and combinations thereof, it is understood that the embodiment may comprise or consist of any of the elements of the group, either individually or in combination with any of the other elements of that group.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

Environments such as space or a potential blast zone require personal protection against mechanical and thermal threats. As explained above in the background section, to provide protection, astronaut and bomb disposal personnel suits employ multiple materials resulting in bulky gear. While improvements in design have improved the performance and reduced the weight and bulkiness of these suits, multiple materials are still required as there is a fundamental material property trade-off between thermal insulation (inverse of thermal conductivity) and mechanical protection (Young's Modulus). For example, thermal protection is provided by porous but mechanically weak para-aramid aerogels, while commercial para-aramid ballistic resistant fibers (e.g., KEVLAR, TWARON) provide poor thermal protection. As noted above, thermal and mechanical protection can be difficult to achieve in a single multifunctional material, as materials traditionally trade-off between these two properties, as a result of structure-function relationships. For example, high-strength materials are generally highly crystalline with a low concentration of defects. However, these highly ordered domains, which offer rigid, simultaneous bond deformation against mechanical insult also offer rapid phonon and heat transport and, thus, provide poor thermal protection. This transition between crystalline and amorphous phases creates a fundamental trade-off between thermal and mechanical protection that is difficult to overcome. The high modulus and strength of KEVLAR result from its para-aramid rigid rod polymer back-bone that forms from liquid crystal solutions with ordered domains that spontaneously align and crystalize under the shear stress of fiber spinning. Commercially available high performance fibers for mechanical protection, such as KEVLAR, are typically between 10 um and 100 um in diameter.

The thermal insulation of NOMEX derives from its meta-aramid, kinked polymer backbone that inhibits polymer packing and results in slow phonon heat transport along unordered bonds throughout the fiber. Due to the polymer packing difference of these aramid materials, each material trades-off between thermal and mechanical protection by orders of magnitude.

Recently, the development of chemically breaking KEVLAR into nanoscale building blocks has enabled the altering of this basic aramid material structure-function relationships: allowing fibers and their aligned crystallites to be dispersed into randomly aligned films. The fabrication of these building blocks has enabled research toward multifunctional materials including para-aramid infrared stealth films and aerogel threads with mechanical properties higher than traditional heat insulation materials. The aerogel threads for example used a porous network of mono-fibrils allowing for thermal insulation while the thread helped bear the mechanical load. However, these aramid building blocks rely on the degradation of para-aromatic system and the formation of fibrils instead of continuous fibers. With structural degradation at the polymer and fiber spatial scales, these aramid materials exhibit lower modulus and ultimate tensile strengths (10 MPa and 3 MPA respectively), lacking the high mechanical performance of traditional KEVLAR and TWARON para-aramid fibers (160 GPa modulus and 5 GPa ultimate tensile strength). As a result, there is still a need to produce continuous para-aramid fibers to obtain these mechanical properties.

To achieve these simultaneous properties, multifunctional materials that are engineered to alter this basic structure-function relationship from the bond-to-nano-macro-scales are needed to achieve the next generation of high-performance fibers with multifunctionality.

A material's strength, or its ability to withstand a force before breaking, arises primarily from its assembly of well-ordered crystalline domains. A material's toughness, or its ability to absorb energy, generally results from disordered amorphous phases. In traditionally engineered materials, these properties are often mutually exclusive, leading to strong but brittle materials such as glasses, or stretchable but weak materials such as rubbers. Looking more specifically at high performance fibers, these materials have high strength values that are inversely proportional to their toughness, allowing them to absorb large initial forces, but often result in mechanical failure after impact forces exceed its strength. This failure arises from the fact that the fiber ratio of strength to toughness is proportional to its ratio of crystalline to amorphous phases. One way that natural systems resolve this conflict is through the integration of these distinct phases. For example, natural spider silks retain both high strength and toughness by having crystalline protein domains (beta sheets) dispersed in flexible amorphous regions. Conventional manufacturing methods and protocols cannot achieve a similar structure. A similar system has yet to be achieved using synthetic or produced fibers due to limitations in the current manufacturing protocols for high performance fibers. Some methods described herein address this deficiency in conventional manufacturing. For example, some methods described herein enable production of fibers having diameters of less than 3 μm where protein crystalline phase formation is controlled during the fiber formation. Some embodiments described herein provide reliable methods of producing PPTA fibers having diameters of less than 3 microns with crystalline protein domain structures as well as long lengths and high length to fiber diameter aspect ratios.

In some embodiments, para-aramid (e.g., PPTA) fibers described herein employ novel structure to improve functionality of materials in extreme environments. Some embodiments described herein provide materials including para-aramid (e.g., PPTA) fibers that beneficially exhibit a combination of a relatively high Young's modulus (e.g., sufficient strength to provide fragmentation protection) and also exhibit a relatively low thermal conductivity to provide thermal insulation. The para-aramid (e.g., PPTA) fibers of the materials described herein have micron to nanoscale dimension diameters and also have strain induced orientation of the polymers in the fibers in accordance with some embodiments. In contrast to conventional high performance fibers having diameters in a range of 10 microns to 1,000 microns, in some embodiments, the para-aramid (e.g., PPTA) fibers described herein have a diameter of less than 3 microns. These small diameter para-aramid (e.g., PPTA) fibers still exhibit preferential polymer domain alignment leading to a high degree of polymer crystallinity and corresponding strength.

For para-aramid materials to achieve greater simultaneous thermal and mechanical performance, in some embodiments, a para-aramid aerogel includes aligned fibers within the aerogel along the direction of mechanical load as in commercial KEVLAR or TWARON materials. Specifically, in some embodiments, an aligned continuous network of nonwoven para-aramid fibers are capable of bearing mechanical loads, while the porous networks limits heat diffusion without compromising structural function. Collectively, this enables the para-aramid fibers to overcome traditional structure-function limitations, enabling truly multifunctional materials

Some embodiments combine the mechanical properties of continuous fibers with the thermal properties of porous networks by manufacturing a porous network of aligned fibers. Some embodiments including spinning para-aramid solutions an immersion Rotary Jet-Spinning (iRJS) platform. To ensure continuous fiber formation, the precursor solution is fluid-like during fiber spinning and solid-like during fiber formation. This enables fabrication of porous, continuous para-aramid fiber sheets (pAFS) with fiber diameters an order of magnitude lower than commercial para-aramid fibers in some embodiments. Although some embodiments exhibited moderately reduced single-fiber mechanics such as Young's modulus and ultimate tensile strength as compared with commercial para-aramid sheets, these pAFS had comparable ballistic resistance to commercial para-aramid sheets while providing 20× the heat insulation capability. With these synergistic properties, in some embodiments, the pAFS act as a multifunctional material that can provide significantly improved simultaneous protection for those operating under extreme environments, such as astronauts, firefighters, and warfighters.

Some embodiments include pAFS having a porous network of aligned, continuous fibers. In some embodiments, the continuous long fibers provide a rigid material to transmit the energy of a mechanical impact across an area larger than the initial impact site while the porosity limits the heat transfer through the material.

Methods of Making Para-Aramid Fibers, Sheets, and Materials

As noted above, some embodiments including a method for fabricating one or more para-aramid fibers (e.g., PPTA fibers). Methods and systems, and resulting fibers and materials are primarily described herein with respect to fabrication of PPTA fibers, however, one of ordinary skill in the art will appreciate that other type of para-aramids may be employed. For example, in some embodiments, the para-aramid of the fibers or materials may be or include poly(para-benzamide). In some embodiments, other rigid rod polymers, which are not necessarily para-aramids may be employed for fibers, materials or sheets. For example, in some embodiments, one or more of the following rigid rod polymers may be employed CAS Registry Nos. 24991-08-0, 24938-64-5, 27307-20-6, 26402-76-6, 28779-61-5, 27252-16-0, 65749-45-3, 37357-28-1, 26402-76-6, 51257-61-7, 31801-22-6, 65749-46-4, 65761-30-0, 65749-48-6, 65749-49-7, and 52270-04-9. In some embodiments, co-polymers with limited order may be in the fibers, materials or sheets. For example, in some embodiments, one or both of CAS Registry Nos. 29153-47-7, and 65749-50-0.

In some embodiments, the method includes providing a solution for spinning. The solution may be referred to herein as a polymer solution, a polymer dope, a spinning solution or a polymer spinning dope. In some embodiments the solution includes a para-aramid (e.g., PPTA) and sulfuric acid. In some embodiments the solution includes a para-aramid (e.g., PPTA), dimethylsulfoxide (DSMO), and potassium hydroxide (KOH). In some embodiments, a weight % of PPTA in the solution is in a range of 0.1 wt % to 2.5 wt %. In some embodiments, the weight % of PPTA in the solution is in a range of 0.3 wt % to 1.5 wt %. In some embodiments, the weight % of PPTA in the solution is in a range of 0.5 wt % to 1.0 wt %. In some embodiments, employing sulfuric acid in the solution, the sulfuric acid is in the range of 80% to 99% by weight in the solution.

In some embodiments employing DMSO in the spinning solution, the DMSO in the solution is the range of 92% to 99.8% by weight. In some embodiments employing KOH in the spinning solution, the KOH in the solution is in the range of 0.1% to 4% by weight.

Further details regarding the solution in some embodiments and the relevance of the concentration of PPTA in the solution and the concentration of the sulfuric acid in the solution are provided below in the Examples section.

In some embodiments, the para-aramid (e.g., PPTA) fibers are fabricated using an iRJS device or system. Descriptions of iRJS devices, systems and methods may be found in U.S. Patent Publication No. 2015/0354094, the entire content of which is incorporated herein by reference. iRJS methods and system facilitate fiber production from non-volatile solvents and from polymers with charged groups. iRJS ejects one or more jets of a polymer solution from one or more orifices of a rotating reservoir. The jets elongate and are solidified in a precipitation bath. In iRJS, the precipitation bath chemically crosslinks or precipitates the polymer fibers, removing the need for using volatile carrier solvents such as those commonly used for conventional rotary jet spinning (RJS). By employing precipitation instead of evaporation, the iRJS enables the fabrication of a variety of polymer fibers having diameters of less than 3 μm that cannot be readily formed using conventional RJS and ES techniques.

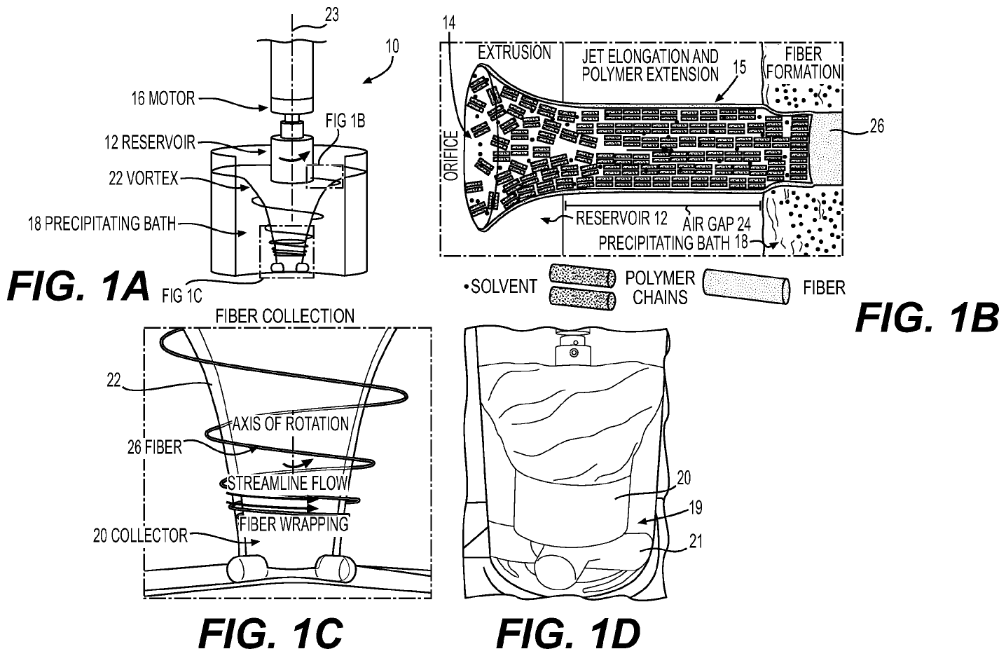

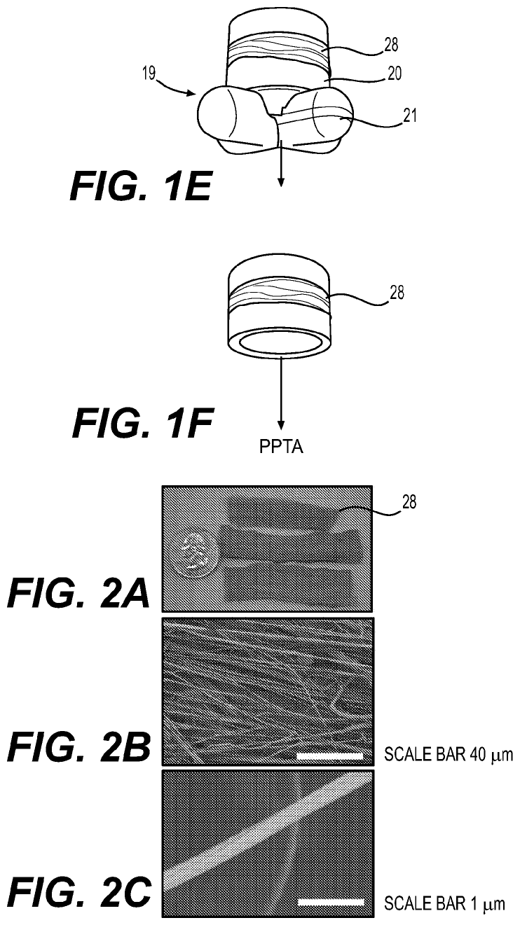

Referring to FIGS. 1A-1C, small diameter (e.g., diameter of less than 3 μm) para-aramid fibers (e.g., PPTA fibers) 26 may be fabricated using an iRJS device or system 10 in accordance with some embodiments. In some embodiments, the iRJS device or system 10 includes a reservoir 12 having one or more orifices 14, which may also be referred to as a spinneret, a motion generator (e.g., a motor 16) configured to impart rotational motion to the reservoir, and a precipitation bath 18, which is also referred to as a precipitating bath 18 herein. In some embodiments, the method for fabricating the one or more para-aramid (e.g., PPTA) fibers includes rotating the reservoir 12 holding the solution about an axis of rotation 23 to cause ejection of the solution in one or more jets 15 from the one or more orifices 14 of the reservoir (see FIGS. 1A and 1B). In some embodiments, the reservoir is rotated at a rotational speed greater than 1,000 rotations per minute (RPM) (e.g., in a range of 3 kRPM to 45 kRPM). In some embodiments, the reservoir is rotated at a rotational speed in a different range. Once ejected into the air gap, the one or more polymer jets thin before entering the precipitation bath 18. The one or more jets 15 of solution are collected in the precipitation bath 18 in which the one or more jets precipitate to form one or more para-aramid (e.g., PPTA) fibers. In some embodiments, the fibers are collected on a collector (e.g., a rotating collector) forming a sheet of fibers, which may also be described as a network of fibers. In some embodiments, after removal of the sheet of fibers or network of fibers from the precipitation bath 18, and, in some embodiments, washing of the fibers or sheets (e.g., with water), lyophilization preserves the network, replacing liquid (e.g., precipitation bath solution and/or washing liquid) in the sheets with air. The iRJS systems and methods describe herein enable production of continuous fibers having very high length to diameter aspect ratios. For example, in some embodiments, a fiber many meters in length and having a diameter of less than 1 μm may be wrapped around a collector.

Changes in temperature influence the viscoelastic properties of materials: an increase in temperature increases the movement of polymer chains resulting in a decrease in viscosity while a decrease in temperature limits their movement causing a shift to elastic dominance. In some embodiments, the temperature of the precipitation bath and/or the temperature of the solution during spinning are selected to obtain desired viscoelastic properties. In some embodiments, precipitation bath 18 has a temperature less than an ambient temperature. In some embodiments, the precipitation bath 18 has a temperature in a range of −1° C. to 5° C. In some embodiments, the precipitation bath 18 has a temperature in a range of −1° C. to 3° C. In some embodiments, the precipitation bath 18 has a temperature in a range of 1° C. to 3° C.

In some embodiments, the temperature of the solution in the reservoir is higher than ambient temperature. For example, in some embodiments, the solution in the reservoir has a temperature in a range of 20-85° C., or of 30-85° C. during spinning.

In some embodiments, the temperature of the precipitation bath is below ambient temperature in one of the ranges described above and the temperature of the spinning solution is above ambient temperature in one of the ranges described above. Description of the relevance of the temperature of the precipitation bath and of the spinning solution is provided in the discussion of the Examples below.

The selection of an appropriate liquid for the precipitation bath is important, as it must dissolve the jet carrier solvent (e.g., sulfuric acid or DSMO and KOH) while simultaneously precipitating or crosslinking the fiber polymer. In some embodiments, the precipitation bath includes water. In some embodiments, sodium hydroxide (NaOH) is added to the precipitation bath 18 during spinning of the fibers to neutralize the sulfuric acid being introduced into the precipitation bath 18 in the jets of solution. In some embodiments, another strong base such as KOH or Ca(OH)₂ may be added instead of the sodium hydroxide to neutralize the sulfuric acid.

In embodiments employing DMSO and KOH instead of sulfuric acid in the spinning solution, an acid, such as HCL or H₂SO₄, may be added to the precipitation bath to neutralize the KOH.

In some embodiments, there is an air gap 24 between the one or more orifices 14 and a surface of the precipitation bath 18 as shown in FIG. 1B. The one or more jets 15 of solution may undergo jet-elongation and polymer alignment due to shear forces in the jet as the jets travels through the air gap as illustrated in FIG. 1B. In some embodiments the air gap may be in a range of 2 cm to 20 cm. In some embodiments, the air gap may be in a range of 2 cm to 10 cm. In some embodiments, the air gap may be in a range of 2 cm to 6 cm. In other embodiments, a different air gap may be employed. In general, the larger the air gap the longer the amount of time that the jets spend being elongated and the smaller the diameter of the resulting fibers; however, there is a limit to the jet elongation in air beyond which the jet breaks up or beads before entering the precipitation bath.

At the end of the air gap, the polymer jet enters the precipitation bath 18 where the carrier solvent diffuses out, and polymeric fiber solidification occurs. In some embodiments, the method includes stirring the precipitation bath 18 during ejection of the one or more jets 15 and collection of the ejected jets in the precipitation bath 18. In some embodiments, a vortex 22 is formed in the precipitation bath 18 (e.g., through use of a second motion generator like a stir bar or stirring element). In some embodiments, the air gap 24 between the one or more orifices 14 and the surface of the precipitation bath 18 is due, at least in part, due to the presence of the vortex 22. In some embodiments, the air gap 24 may be positioned centrally in the liquid vortex 22 in the precipitating bath 18. In some embodiments, the air gap 24 may be adjustable through one or both of an amount of liquid in the precipitation bath and a control of the liquid vortex (e.g., such as by controlling the rotation rate of a spin bar or other rotating element in the precipitation bath).

In some embodiments, the formed para-aramid (e.g., PPTA) fibers each have a diameter of less than 3 micrometers. In some embodiments, the formed para-aramid (e.g., PPTA) fibers each have a diameter in a range of 400 nm to 2 μm. In some embodiments, the formed para-aramid (e.g., PPTA) fibers each have a diameter in a range of 400 nm to 1.5 μm. In some embodiments, the formed para-aramid (e.g., PPTA) fibers each have a diameter in a range of 400 nm to 1 μm. Discussion of how claimed methods produce fibers in these diameter ranges is provided in the description of the Examples section below.

In some embodiments, the resulting para-aramid (e.g., PPTA) fibers are collected on a collector 20 within the precipitation bath 18. For example, in some embodiments, the iRJS system 10 includes a collector 20 positioned at least partially submerged within the liquid of the precipitation bath 18 during rotation of the reservoir to eject the jets as shown in FIGS. 1A, 1C and 1D. In some embodiments, the fibers are collected on the collector 20 by wrapping around the collector within the precipitation bath as shown in FIGS. 1A, 1C and 1D. In some embodiments, the collector 20 is part of a rotating collector 19 that also includes a motion generating element 21 (e.g., a cross-shaped stir bar) that is used to stir the precipitation bath 28 forming the vortex 22 within the precipitation bath 18 as shown in FIGS. 1C and 1D. FIG. 1E shows PPTA fibers wrapped around a rotating collector 19 after the rotating collector is removed from the precipitation bath. In some embodiments, collection of the continuous fibers around the rotating collector forms pAFS (e.g., PPTA fiber sheets). FIG. 1F shows formed PPTA fibers wrapped around the collector 20 after separation of the motion generating element 21 from the collector 20. FIG. 2A is an image of PPTA small diameter fiber sheets fabricated by collecting continuous fibers on the rotating collector after about 30 seconds of spinning. The SEM image of FIG. 2B shows the individual PPTA fibers in a sheet. The SEM image of FIG. 2C shows that the diameter of a single fiber is less than 1 micron and is on the nanometer scale.

In some embodiments, a shape of a container of the precipitation bath 18 and/or an additional flow of precipitation bath liquid introduced into and/or flowing out of the precipitation bath 18 is used to generate the vortex. In some embodiments, the formed fiber flows out of the precipitating bath and is collected downstream.

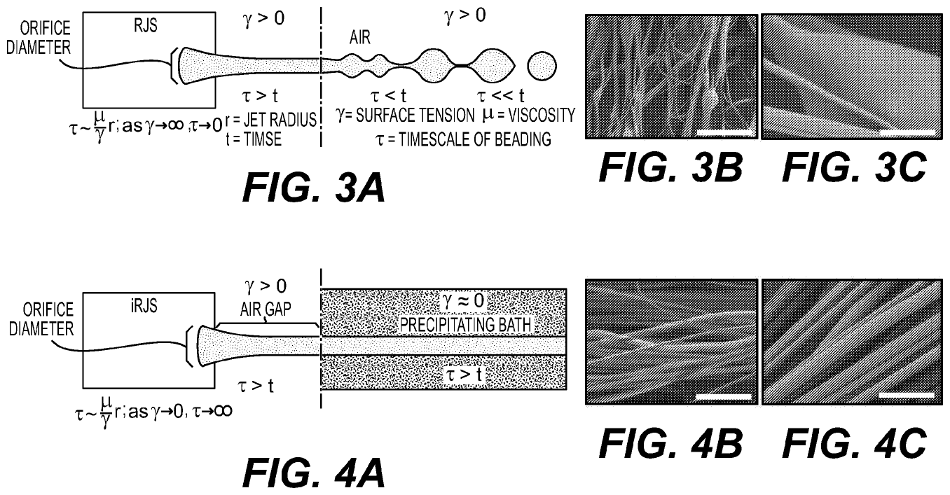

The use of a precipitation bath in iRJS reduces the tendency towards beading of the ejected polymer jet driven by the Raleigh Plateau instability, which limits the parameter space of dry rotary jet spinning or electrospinning. Before skin formation or phase separation suppresses this hydrodynamic instability, the timescale of fiber beading is governed by τ≈μ, where μ is the solvent viscosity, γ is the surface tension, and r is the jet radius, as depicted in FIG. 3A that schematically illustrates a dry rotary jet spinning (RJS) process for purposes of comparison. The resulting beads from the RJS process are shown in the images of FIGS. 3B and 3C. By spinning into a precipitation bath that is miscible with the carrier solvent, but precipitates the polymer, the surface tension of the interface approaches zero, y→0, increasing the time scale of bead formation, τ→∞, as depicted in FIG. 4A. As a result, iRJS fibers are bead-free (see FIGS. 4B and 4C), provided that the air gap is sufficiently small, such that the polymer solution reaches the precipitating bath before beading occurs. In addition to controlling fiber morphology, the iRJS device may be used to control fiber diameter by (i) varying air gap distance, (ii) rotation speed, and/or (iii) solution concentration. Further explanation of the influence of rotation speed and solution concentration on fiber diameter is provided in the Examples section below.

In some embodiments, the method enables control of a ratio of crystalline/amorphous phase in the resulting fibers. In some embodiments, the method produces para-aramid fibers including nano-crystallites, with length scales ranging from 20-500 nm, confined in an amorphous matrix.

Para-Aramid Fibers, Sheets, Materials and Uses Thereof

Embodiments include para-aramid (e.g., PPTA) fibers, sheets and materials. For example, some embodiments provide a material includes a plurality of polymeric fibers formed, at least in part, from a para-aramid polymer (e.g., PPTA). In some embodiments, the para-aramid fibers have small diameters relative to commonly commercially available para-aramid fibers, such as commercially produced PPTA fibers. For example, in some embodiments, the plurality of para-aramid fibers (e.g., PPTA fibers) may have an average fiber diameter in a range of 300 nm to 3 μm, of 400 nm to 2.5 μm, of 400 nm to 2.0 μm, of 400 nm to 1.5 μm, or of 400 nm to 1.0 μm. In some embodiments, the plurality of para-aramid fibers (e.g., PPTA fibers) may have an average fiber diameter of less than 3 μm, less than 2.5 μm, less 2.0 μm, less than 1.5 μm, less than 1.0 μm, less than 900 nm or less than 800 nm.

In some embodiments, the para-aramid fibers of a material may have small diameters combined with high length to diameter aspect ratios. For example, in some embodiments, a plurality of para-aramid (e.g., PPTA) fibers of a material may have an average length to diameter aspect ratio of greater than 1000 to 1, of greater than 10,000 to 1, of greater than 100,000 to 1, of greater than 1,000,000 to 1. In some embodiments, the aspect ratio is in a range of 1000 to 1 and 100,0000,000 to 1, in a range of 1000 to 1 and 10,000,000 to 1, in a range of 10,000 to 1 and 10,000,000 to 1, in a range of 10,000 to 1 and 1,000,000 to 1, in a range of 100,000 to 1 and 10,000,000 to 1, or in a range of 100,000 to 1 and 1,000,000 to 1.

In some embodiments, the para-aramid fibers include nano-crystallites, with length scales ranging from 20-500 nm, disposed in an amorphous matrix.

In some embodiments a material including the plurality of para-aramid (e.g., PPTA) fibers may exhibit a desirable combination of a relatively high Young's modulus and a relatively low thermal conductivity. For example, in some embodiments, the plurality of para-aramid (e.g., PPTA) fibers may have an average Young's modulus along a longitudinal axis of the fiber in a range of 1 GPa to 200 GPa, of 1 GPa to 130 GPa, of 1 GPa to 100 GPa, of 1 GPa to 50 GPa, of 1 GPa to 30 GPa, of 1 GPa to 25 GPa, or of 1.5 GPa to 5.5 GPa. In some embodiments, the plurality of para-aramid (e.g., PPTA) fibers may have an average Young's modulus along a longitudinal axis of the fiber greater than 1 GPa, greater than 10 GPa, or greater than 20 GPa.

In some embodiments, the plurality of para-aramid (e.g., PPTA) fibers of the material may have an average Young's modulus along a longitudinal axis of the fiber in any of the ranges as described herein in combination with the material having a thermal conductivity (k) in a range of 0.005 W/(m·K) to 10 W/(m·K) as measured normal to a surface of the material and perpendicular to the orientation direction of the at least some of the fibers. In some embodiments, the plurality of para-aramid (e.g., PPTA) fibers of the material may have an average Young's modulus along a longitudinal axis of the fiber in any of the ranges as described herein in combination with the material having a thermal conductivity (k) in a range of 0.01 W/(m·K) to 10 W/(m·K) as measured normal to a surface of the material and perpendicular to the orientation direction of the at least some of the fibers. In some embodiments, the plurality of para-aramid (e.g., PPTA) fibers of the material may have an average Young's modulus along a longitudinal axis of the fiber in any of the ranges as described herein in combination with the material having a thermal conductivity (k) in a range of 0.01 W/(m·K) to 3.0 W/(m·K) as measured normal to a surface of the material and perpendicular to the orientation direction of the at least some of the fibers.

In some embodiments, the material is a nonwoven material.

In some embodiments, the material may have a volume density in a range of 0.001 g/cm³ to 0.5 g/cm³, in a range of 0.01 g/cm³ to 0.5 g/cm³, or in a range of 0.05 g/cm³ to 0.2 g/cm³.

In some embodiments, the material also includes a polymer disposed between fibers in the plurality of para-aramid (e.g., PPTA) fibers. In some embodiments, the polymer comprises one or more of polyurethane, a hydrogel, and polyvinyl butyral. In some embodiments, the material further comprises phenolic resin.

While commercial para-aramid fiber diameters typically range from 10-20 um, the significantly smaller diameters of para-aramid (e.g., PPTA) fibers in some embodiments (e.g., 500-1000 nm) provide a 10-20 times increase in surface area-to-volume ratio. For composite materials, the smaller diameter PPTA fibers may enhance fiber dispersion within matrix materials, increasing uniformity, minimizing local stress concentrations, and increasing the number of fibers available for bridging crack formations. Furthermore, the higher surface area-to-volume ratio of fibers can improve adhesion to the matrix, strengthening the composite.

Some embodiments may include a garment or item of protective clothing including any of the materials described herein. In some embodiments, the garment or item of protective clothing provides fragmentation protection, fragmentation resistance, ballistic protection, or ballistic resistance for at least a portion of a body.

Some embodiments provide a layered material including a first layer, a second layer including any of the materials described herein comprising para-aramid or PPTA fibers, and a third layer, with the second layer disposed between the first layer and the third layer. In some embodiments, additional layers of the materials described herein para-aramid or PPTA fibers may be included. In some embodiments, the first layer includes a material different than the material of the second layer and the third layer includes a material different than the material of the second layer. In some embodiments, the first layer is a woven material, the third layer is a woven material, or both are woven materials. In some embodiments, the layered material includes additional layers of material comprising para-aramid or PPTA fibers. Example B, described below, includes example layered materials including one or more non-woven para-aramid fiber sheets and woven layers. In some embodiments, alternating traditional/commercial fragmentation protection materials (e.g., KEVLAR, TWARON) with small fiber diameterpAFS, as disclosed herein, may provide enhanced ballistic protection and enhanced heat insulation. In Example B, a commercially produced woven layer, specifically a TWARON layer, is employed. Although Example B employs TWARON layers for the woven layers, it should be appreciated that other woven or non-woven materials may be substituted without departing from the spirit/scope of this disclosure.

Some embodiments may include a garment for providing fragmentation or ballistic protection to a portion of a body, the garment including any of the materials, layered materials, or composite materials described herein. Example materials are characterized for their ability to provide fragmentation protection in Example B described below. In some embodiments, the garment is at least a portion of a flight suit or a space suit. In some embodiments, the layered material may be fabricated into a garment (e.g., flight suit, space suit, vest). The garment may be configured to, in part, reduce (or protect) the user from the impact of explosions and fragmentation (e.g., a military vest). Some embodiments may employ a composite material in ballistic protection equipment (e.g., in a helmet or other article of clothing).

### EXAMPLES

### Example A

Formation of PP TA Fibers and Fiber Sheets by iRJS

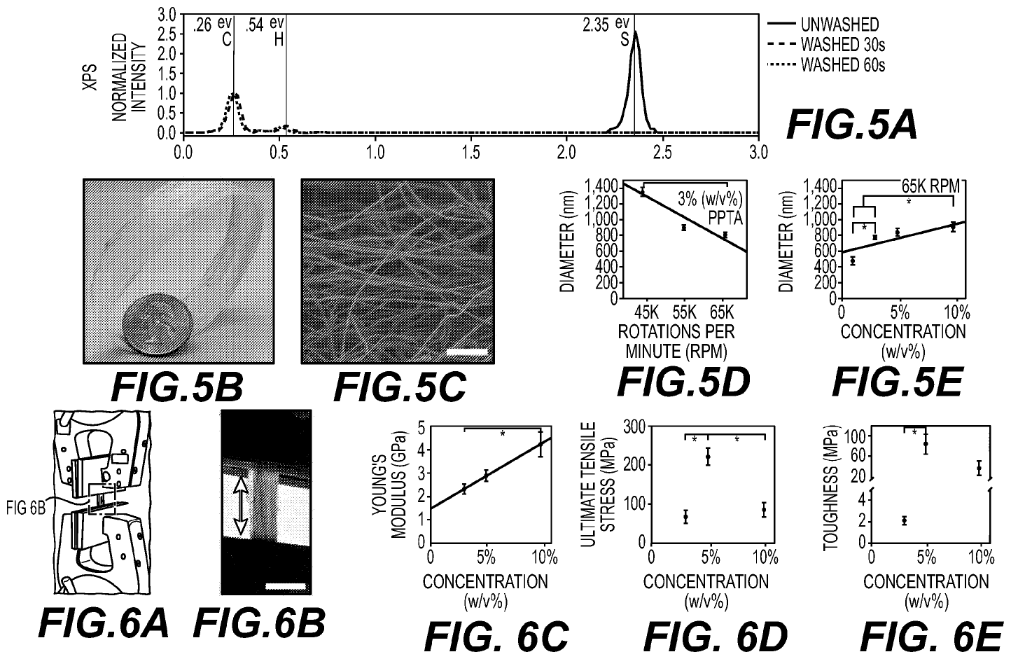

Para-aramid (specifically, PPTA) continuous fibers and para-aramid (specifically, PPTA) fiber sheets (pAFS) were formed using an iRJS system. The iRJS system was used to make an aligned continuous nonwoven, porous network of para-aramid fibers in which the fibers bear the mechanical load and the network porosity limits heats diffusion to overcome the traditional structure-function trade-offs and enable a multifunctional material. Solutions including different concentrations of PPTA, specifically, KEVLAR, in a solvent, specifically, sulfuric acid, were spun forming jets that entered a precipitation bath where they solidified into fibers and were collected on a rotating collector (see FIGS. 1A-1F). The collection process on the rotating collector formed a cylindrical sheet of the fibers as the formed fibers were being collected. In the precipitation bath, the sulfuric acid solvent was diluted (e.g., at least 1000 times). The resulting fibers collected into sheets (see FIGS. 1E-2C, 4B, 4C and 5B) were washed with distilled water for 30 seconds followed by a 1 hour drying step at 100° C. to ensure that any sulfuric acid residue was removed. The successful removal of sulfuric acid impurities was confirmed by energy-dispersive X-ray spectroscopy (EDS) (see FIG. 5A).

Applying this procedure, small diameter PPTA fibers were fabricated with various diameters and tensile strengths. Fiber diameter was controlled in the iRJS system by adjusting polymer concentration and/or the shear forces applied by varying rotational spinning speed. Increasing spinning speed decreased fiber diameters. For example, for 3% (wt/v %) PPTA polymer solutions, increasing spinning speed from 45 k RPM to 65 k RPM decreased the resulting fiber diameter from 1300 nm to 800 nm as shown in FIG. 5D. In contrast, increasing polymer concentration increased the resulting fiber diameter. For example, for a spinning speed of 65 k RPM, PPTA concentrations of 1, 3, 5, or 10% (wt/v %) produced sheets of fibers with mean diameters of 500, 800, 850, or 900 nm, respectively (see FIG. 5E).

Mechanical Properties of Resulting PPTA Fiber Sheets

Fibers wrapped around the collector formed PPTA sheets, whose mechanical properties were tested (see FIGS. 1E, 1F. 2A, 5B). To determine the mechanical properties of the PPTA fiber sheets, uniaxial tensile testing was performed on macroscopic fiber sheets of fibers spun at 65 k RPM at varying PPTA concentrations as shown in FIGS. 6A and 6B. The results of the testing appear in the graphs in FIGS. 6C through 6E. The PPTA fiber sheets spun from a 10 w/v % concentration of PPTA in the spinning solution (“the 10% sheets”) displayed the highest Young's modulus as shown in FIG. 6C. However, the 10% sheets displayed lower ultimate tensile stress as compared with the PPTA fiber sheets spun from a 5 w/v % concentration of PPTA in the spinning solution (“the 5% sheets”) (see FIG. 6D). The PPTA fiber sheets spun from 3 w/v % concentration of PPTA in the spinning solution (“the 3% sheets”) had lower ultimate tensile stress and a lower Young's modulus than those of the 5% sheets (see FIGS. 6C and 6D). All the macroscopic PPTA fiber sheets had lower Young's modulus and ultimate tensile stress compared to the reported values for single fibers of KEVLAR types 29 and 49: Kevlar 29: Modulus 77 GPa, Tensile Strength 3.30 GPa, Ultimate Tensile Strain 3.9%; Kevlar 49: Modulus 82.7, Tensile Strength 3.01 GPa, Ultimate Tensile Strain 3.4%. (see Roenbeck, M. R. et al. Structure—Property Relationships of Aramid Fibers via X-Ray Scattering and Atomic Force Microscopy. J. Mater. Sci. 2019, 54 (8). https://doi.org/10.1007/s10853-018-03282-x.) However, this apparent difference is in part due to testing the nano-fibrous network instead of single fibers. For instance, a 1000-fold difference in apparent Young's modulus has been reported for single PCL nanofibers, compared to values measured for macroscopic sheets composed of the same fibers.

Use of the rotating collector produced anisotropic fiber sheets in which fibers in the sheet were preferentially oriented in a direction corresponding to wrapping around the collector, which could be described as azimuthally with respect to a rotation axis of the collector. Assuming that the fibers of the anisotropic sheets span the entire sheet length, the toughness, which is the total amount of energy required to fracture all the fibers in the sample, whether in concert or one by one, should be less influenced by disorganization of the fiber sheets. To this point, the tensile toughness of the highly crystalline 5% and 10% fiber sheets were 81±20 MPa and 33±14 MPa, respectively (see FIG. 6E), which is comparable to that of commercially available microfibers reported at 50 MPa.

Characterization of Microstructure of PP TA Fibers and Fiber Sheets

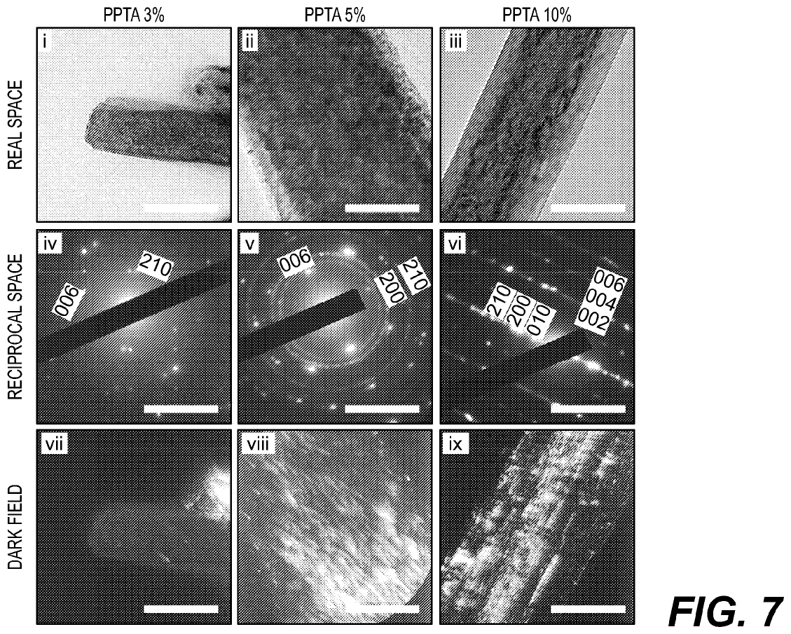

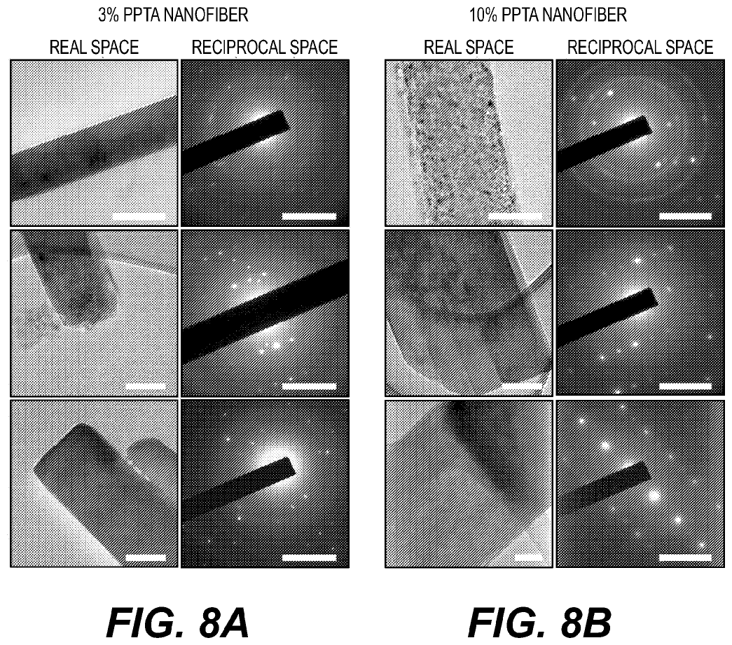

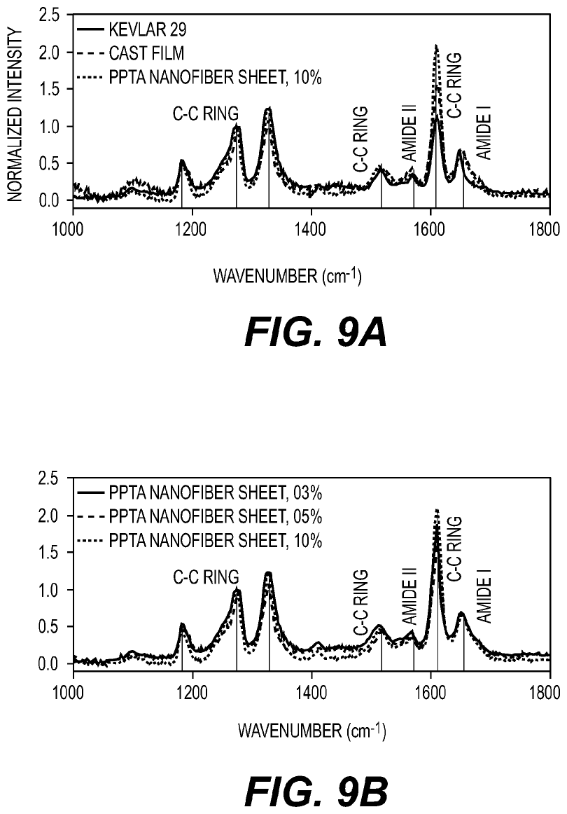

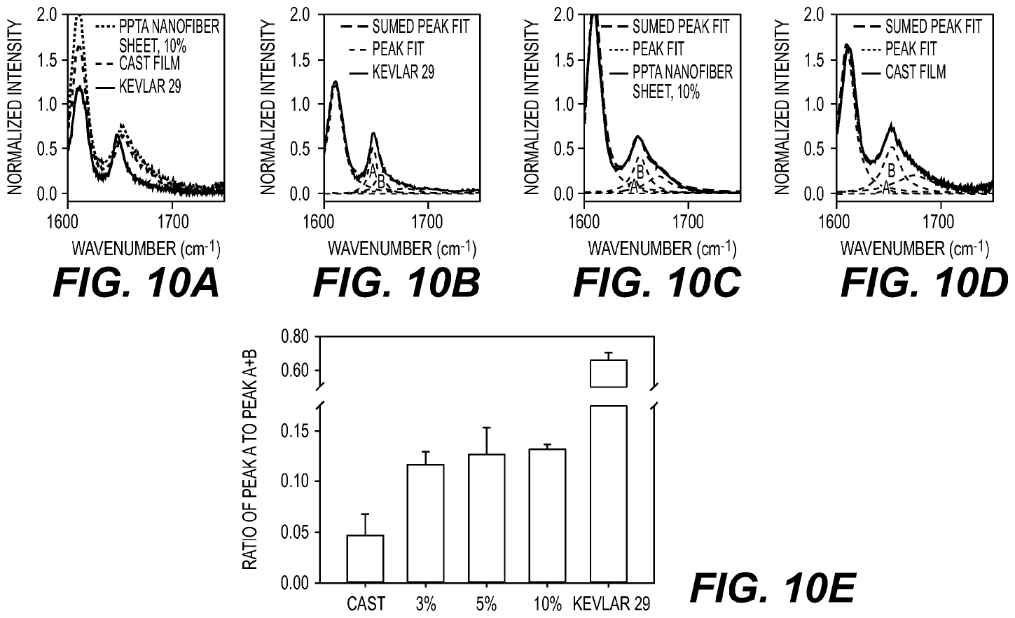

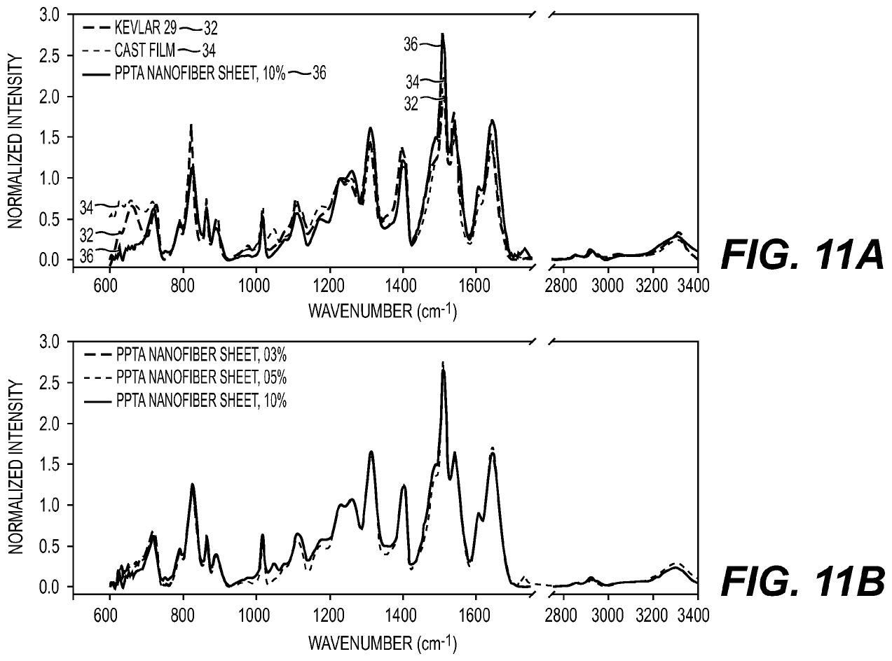

For many commercially produced PPTA fibers, Young's Modulus increases with increasing crystallinity while toughness decreases. To determine the relationship of the PPTA fiber mechanics with crystallinity, local crystallinity of single PPTA fibers were evaluated using transmission electron microscopy (TEM) (see FIGS. 7, 8A, and 8B). The 3%, 5%, and 10% (wt/v %) precursor solutions spun at 65 k RPM all produced semi-crystalline PPTA fibers as evidenced by the TEM diffraction patterns (see FIGS. 7A, 7B, and 7C) without a loss in the PPTA polymer bond chemistry as evidenced by Raman spectroscopy data of the fiber sheets and comparison KEVLAR 29 sheets and cast films (see FIGS. 9A-10E) and Fourier Transform Infrared (FTIR) spectroscopy data (see FIGS. 11A and 11B). For the 3% fibers, amorphous ring diffraction caused by randomly aligned polymer chains was dominant (see FIG. 7 image iv), while for the 5% and 10% samples, discrete diffraction with high local band intensity was seen (see FIG. 7 image v and FIG. 7 image vi, respectively), indicative of aligned polymer chains and crystalline domains. Furthermore, for the 10% sample, the meridial (002, 004, 006) and equatorial (010, 200, 210) diffraction bands along with a crystalline core and amorphous skin were observed (see FIG. 7, images iii and ix). These variations follow the trend in Young's moduli observed in the mechanical tests of the 3, 5 and 10% samples, as increased crystalline morphology should lead to stiffer, more brittle fiber materials. Nevertheless, when the bulk crystallinity of macroscopic fibrous sheets were investigated using Raman (see FIGS. 9A-10B) and FTIR spectroscopy (see FIGS. 11A-11B), no quantifiable differences between the nano-fibrous samples were observed. In these Raman and FT-IR spectroscopy tests, all three fiber samples had similar degrees of crystallinity, which were higher than that of a comparison cast film, but significantly lower than that of a reference commercial KEVLAR 29 microfiber (see FIG. 10E). This inconsistency between the local crystallinity as observed by TEM and the bulk measurements relying on Raman and FTIR spectroscopy, might arise from TEM imaging relying on fibers of diameters smaller than the average of the production run. It might also indicate that only local areas of increased crystallinity are present in the high concentration samples.

### Example B

iRJS Fabrication System for Larger Size Samples and Yarns

An iRJS system for production of larger size samples and continuous production of fibers and yarns was developed and produced. While the iRJS system employed for fabrication of sheets in Example A above was capable of producing novel small diameter fiber structures from non-volatile dopes, it previously only enabled the fabrication of small samples (1 cm by 5 cm) from 3 mL solutions. This limitation on sample size prevented the production of samples in sufficient sizes for fragmentation testing as edge affects would influence the performance of the material. Continuous spinning of solutions enables greater volume of production. Continuous spinning requires a spinning reservoir that can be continuously fed and a larger batch to hold greater fibers. Continuous production however has drawbacks. For example, instabilities can form in the polymer jet if it undergoes shear forces that are too great. Such shear forces could result in shark skinning where the fiber forms rough, undulating features. Further shear stresses cause destruction of the fiber surface. Before these instabilities occur however, die swelling may occur. Die swelling is where the extruded jet is greater in size than the die it passed through. Shear forces needed to be controlled in the scaled iRJS to decrease die swelling and avoid these instabilities and large fiber diameters. Finally, in addition to scaling the production of sheets, scaling the production of yarns enables industrial scalability of the system in some embodiments.

Engineering Continuous Loading Reservoir to Enable the Fabrication of Continuous Fibers

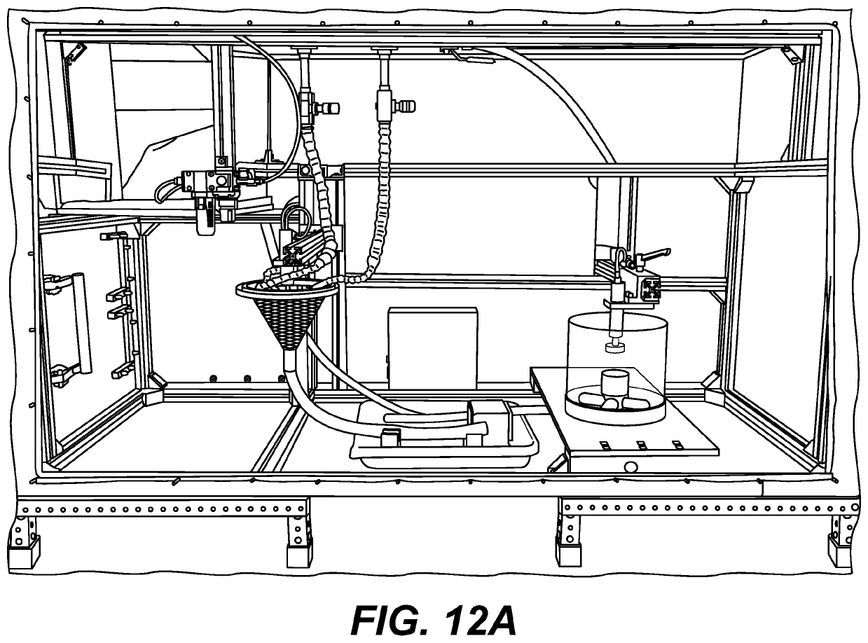

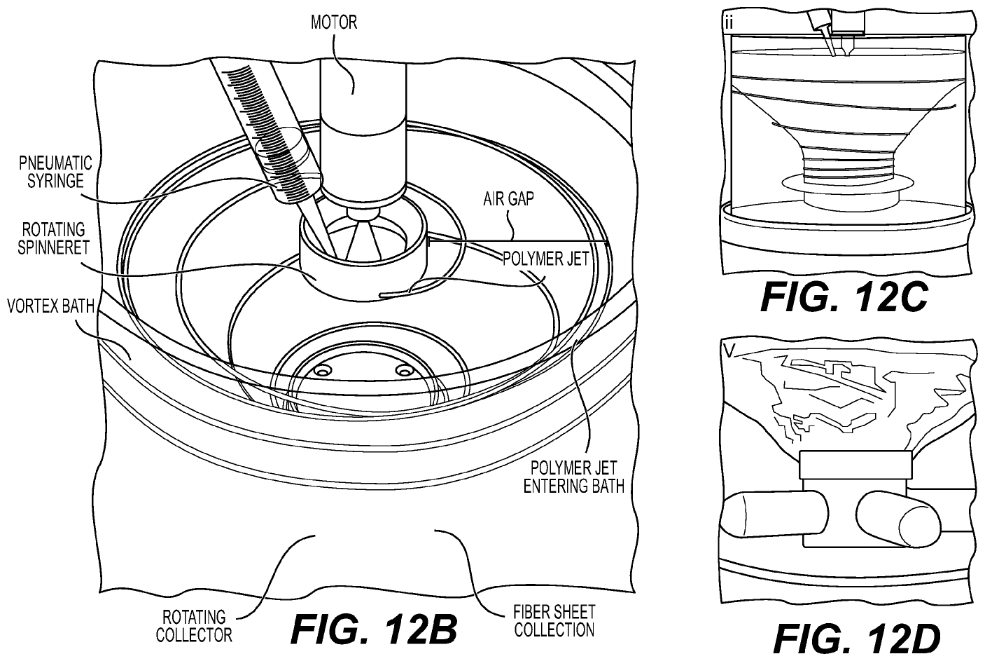

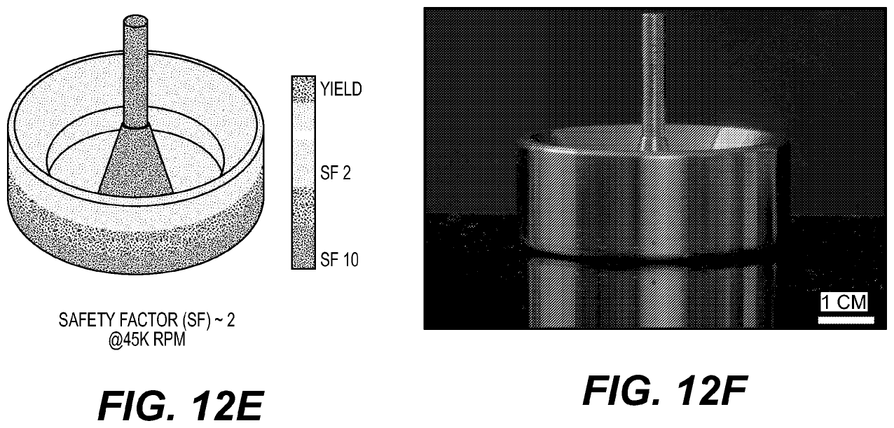

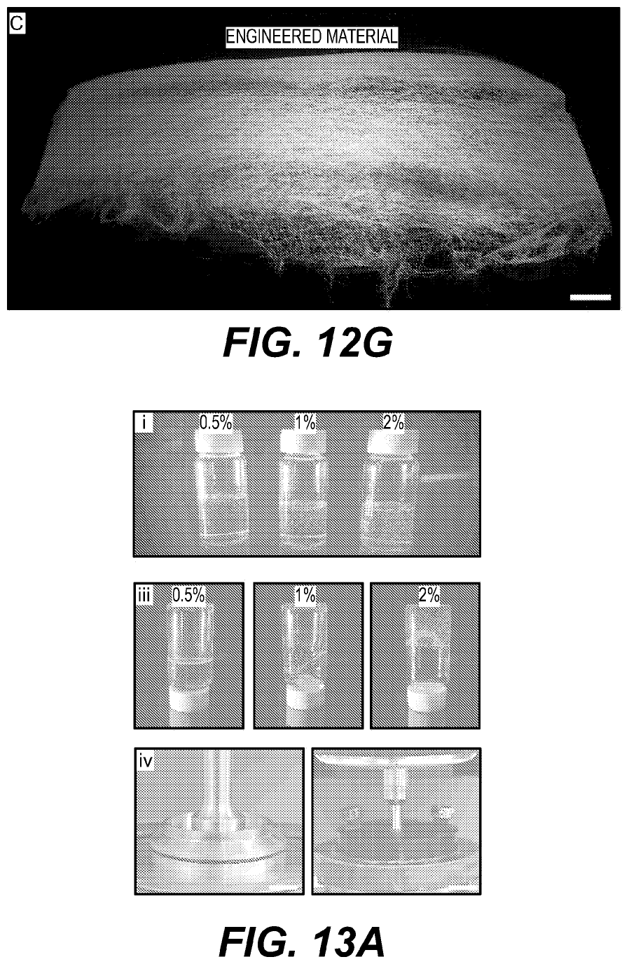

The iRJS system described with respect to Example A was redesigned to make large sheets and to make continuous yarns (see FIGS. 12A-12D). To continuously spin fibers, a top loading reservoir with the ability to be continuously feed was employed. However, as the motor that spins the reservoir speeds up to 80 k RPM and that the motor is oriented above the reservoir due to the position of the bath, the reservoir needed to be at least double the width of the motor to allow access to a polymer feed. In addition, the reservoir needed a lipped cap to contain the polymer solution to ensure that the polymer exits the orifice instead of flying out the top (see FIG. 12B). Increasing the diameter of the reservoir to 30 mm or greater and adding a topped lip would increase weight and size. These requirements cause most materials for the reservoir to fail at speeds greater than 30 k RPM. Simulation analysis of reservoir design and material selection was conducted to build a reservoir with a safety factor of at least 2. For example, it was determined that a reservoir made from common milling aluminum (Grade 2011) would fail at 45 k RPM. However, a reservoir machined from aluminum grade 7075 would enable spinning a reservoir of 45 mm to speeds of 80 k RPM with a safety factor of 5. To protect the 7075 reservoir from slight corrosion for applications other than the spinning of PPTA, the 7075 reservoirs could be coated with an anodized Teflon hard coat with a 25 um buildup (ASTM B117). This would allow the reservoir to be used with slightly corrosive solutions and to avoid material degradation due to exposure of salts which are usually employed to spin biopolymer fibers. However, such a coating would be insufficient to withstand a sulfuric acid spinning solution over time.

As sulfuric acid would eat away at the hard coat, another material was needed to spin PPTA solutions continuously. Some materials capable of withstanding sulfuric acid include glass, ceramics, Stainless Steel 316L, and Hastelloy C276. Glass and ceramics were not chosen as any sub-fracture or fault could cause the reservoir to break at high speeds seemingly instantly. As plastic deformation allows for visual inspection and removal of a failing component, the reservoir material was chosen to be metal. Because Stainless Steel 316L only provides corrosion resistance to splashes of sulfuric acid (not full immersion), Hastelloy C276 was chosen. The Hastelloy C276 reservoir was designed using a similar simulation with a safety factor of 2 at 45 k RPM (see FIG. 12E). Any rotation faster than 45 k RPM could cause the reservoir to fail and any plastic deformation or ‘wobble’ in the reservoir means it needs to be replaced before failing catastrophically. An image of the Hastelloy C276 reservoir appears in FIG. 12F. The reservoir included two orifices each having a diameter of 1 mm. To verify the hole size of the orifices, plates with varying hole sizes were manufactured and then sectioned in half to verify that the hole ran true throughout the 4 mm thickness. For all cuts ranging in size from 2 to 0.170 um, the hole sizes were roughly 10% larger than drill bit size.

Scaling the iRJS Yarn Formation

To scale the iRJS yarn capability to produce small diameter fiber yarns, a funnel system was employed to create the vortex. A PVDF diaphragm pump was selected to recirculate the bath through the funnel continuously without concern of light corrosive liquids. The iRJS reservoir was placed into the funnel using a linear motor. After spinning, the fiber would be wound up by the funnel, directed with the movement of the water to a collector that would spool the yarn. The materials that were characterized and tested were produced fibers and non-woven sheets instead of yarns, however, the same system with a funnel modification could be used for the production of yarns from small diameter para-aramid fibers.

Control of Fiber Production

To produce pAFS, poly(para-phenylene terephthalamide) sulfuric acid (PPTA-H₂SO₄) solutions were injected to the reservoir, which can also be described as a “spinneret”, as a continuous flow. As explained above, the reservoir itself was machined out of Hastelloy 276 to ensure mechanical stability at rotation speeds and chemical compatibility with sulfuric acid (see FIG. 12F). Once ejected into the air gap, the polymer jet thins out before hitting a precipitating bath. Here, diffusion drives out the sulfuric acid from the jet into the water bath, resulting in the formation of a solid fiber. The bath itself is rotating due to a stirring collector; the bath therefore pulls the fibers along the streamlines of the vortex onto the collector (see FIGS. 12B and 12C). During collection, the fibers interconnect to make a network. After spinning, lyophilization preserves that network, replacing water with air. Using this approach, thin continuous sheets of para-aramid fibers were produced from 1% (wt %) PPTA solutions (see FIG. 12G). Initial production was limited to 1 g of material sample, with a 1 cm by 5 cm width to length dimensions. Additionally, initial thin sheets showed limited consistency, marking them as insufficient for ultimate ballistic and heat performance testing. This limited size and inconsistency resulted from a lack of rheological control of the precursor material.

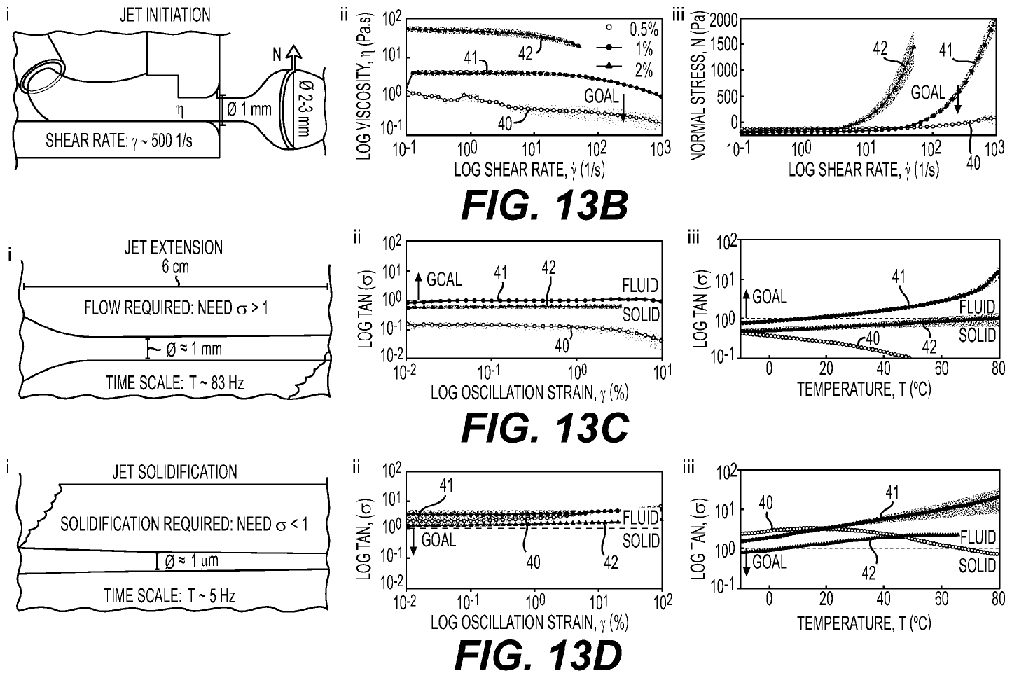

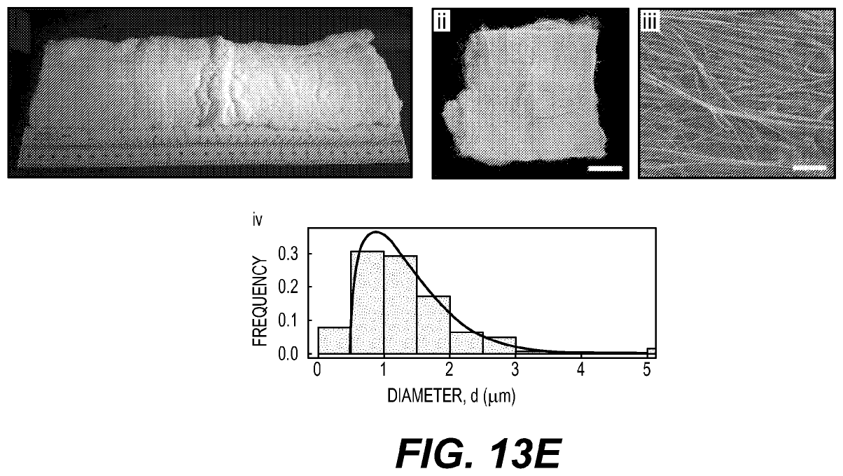

To ultimately test the material's performance in fragmentation and heat protection, fragmentation testing and heat testing should be performed. Fragmentation or ballistic testing requires sheets of a 10 cm by 10 cm minimal size. To be able to fabricate sheets of this size, and to reliability control fiber production, an understanding of the viscoelastic properties of the PPTA-H₂SO₄ spinning solutions during spinning as measured on a rheometer was critical (see FIGS. 13A-13D). To begin the spinning process, jet initiation requires the solution to be shear-thinning and ideally to exit the orifice with the smallest possible diameter, thus allowing the production of fibers with a diameter on the scale of 1 μm (see FIG. 13B, schematic i). A viscosity decrease of the solution with increasing shear force during spinning helps to ensure that the solution is shear thinning: with an increasing shear rate, the viscosity of the material decreases allowing the solution to more-readily extend and narrow into a jet during spinning. Shear rates relevant to the iRJS are at a minimum 100 l/s and greater depending on rotation speed and orifice diameter. At these shear rates, the 0.5% and 1% solutions underwent shear thinning, while the 2% solution deformed and broke apart into pieces and was not stable under rheological testing (see FIG. 13B, graph ii).

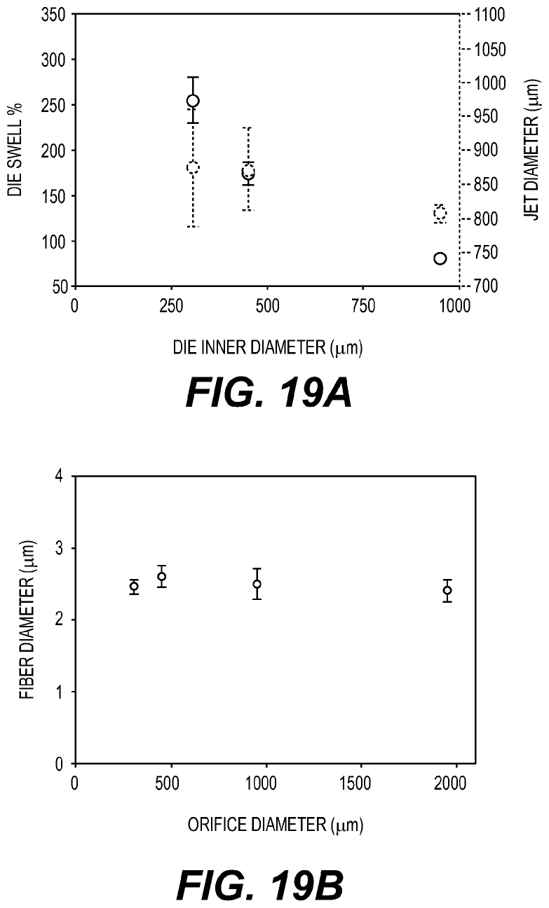

Normal force generation can lead to die swelling where the jet of a solution exiting an orifice swells to a size greater than the orifice. The normal force generation across the surfaces adds a pressure that is released when the solution leaves the orifice. To ensure the solution had minimal jet size after exiting the orifice, the jet needs to have a minimal normal force during spinning. While Newtonian solutions have 10% die swelling at high shear rates, some viscoelastic polymer dopes may have die swelling higher than 300% and as low as 50%. A high positive normal force generation leads to a high die swelling ratio while a negative normal force leads to a low die swelling ratio. While increasing the spinning speed and resultant shear rate causes a decrease in jet size during jet thinning, this growth in shear rate results in increased normal force generation (see FIG. 13B, graph iii). To avoid excess die swelling, 5 k RPM was chosen to accelerate with a shear rate of 500 l/s to thin the 1% solution into thin jets. While decreasing the size of the orifice would decreases the initial size of a jet, decreasing the orifice would also increase the shear rate leading to a higher normal force generation and ultimately similar fiber diameters. FIG. 19A includes a graph of die swelling for various orifice diameters and FIG. 19B includes a graph of resulting fiber diameters for various orifice diameters showing that for some solutions and spinning parameters, decreasing orifice diameter does not necessarily result in a reduction of the diameter of the produced fiber.

During extension from the orifice, the solution needs to thin into a jet and so should be viscous dominant, similar to other fiber spinning processes (see FIG. 2C, schematic i). Being viscous dominant helps ensure continuous jet flow. If, however, a solution is elastic during extension from the orifice instead of viscous dominant, it would bead instead of thinning, leading to short fibrils and incomplete fibers. In contrast, during collection, the dope needs to be elastic dominant to ensure the jet does not deform before solidifying (see FIG. 13D, schematic i). To measure these properties, oscillatory shear of a rheometer was used to probe the solutions at a time scale relevant to fiber spinning (5 k RPM˜83 Hz) and collection (300 RPM˜5 Hz). It was reasoned that by mimicking these rotational speeds, forces would be applied to the dope comparable to those experienced during the fiber formation process. When the tangent (δ) (ratio of viscosity to elasticity) is greater than 1, then the material is viscous dominant. Rheological testing revealed low concentration dopes (0.5%, 1%, 2%) to be elastic dominant during spinning (tangent (δ)=0.1, 1, 0.9 respectively; FIG. 13C, graph ii) and viscous dominant during collection (tangent (δ)=2, 4, 3 respectively; FIG. 13D, graph ii), which are the opposite properties as required in both cases. This trend of decreasing elasticity with longer times (lower time scale) is common among polymer dopes, where generally at faster time scales, a polymer solution becomes more elastic dominant because the polymer chains do not have time to relax, a characteristically viscous effect. Using these solutions with these rheological properties at room temperature therefore leads to poor fiber formation. To enable the required tangent (δ) values for spinning and collecting, another variable was examined.

Changes in temperature influence the viscoelastic properties of materials: an increase in temperature increases the movement of polymer chains allowing for a decrease in viscosity while a decrease in temperature limits their movement causing a shift to elastic dominance. At an 83 HZ frequency relevant to spinning, the material needs to be elastic-dominant. Increasing temperatures of the solution during rheometric studies from −10° C. to 80° C. showed an increase in tan(δ) for the 1% and 2% solutions (FIG. 13C, graph iii). The 1% solution became viscous dominant at solution temperatures of 18° C. or greater. Interestingly, the 0.5% solution does not follow the trend of the other solutions. This is likely because PPTA-H₂SO₄ spinning solutions have different packing at 1% and 2% concentrations than at more dilute concentrations. In addition to being viscous dominant during jet formation, solutions need to be elastic-dominant after jet thinning when entering the bath, to ensure the formation of consistent fibers. More specifically, the jet in the bath needs to have a characteristic time scale, or the time required for the material deform from its original shape by relaxation, that is longer than the time scale of diffusion of the sulfuric acid. As diffusion will be dependent on the ultimate size of the fibers, an elastic-dominant material during collection is preferred as this will allow for the sulfuric acid diffuse out before the jet collapses. Only the 2% solution became elastic-dominant at any temperature at a 5 Hz time scale, which occurred at 2° C. (see FIG. 13D, graph iii). However, as the solution was elastic-dominant during spinning, it was not a suitable material to choose for spinning. As a result, the 1% solution, which had the smallest viscous component at 5 Hz, was selected, as this would allow the greatest time for solidification to occur before relaxation of the jet returned it to deflated shape.

From the rheological data, the 1% solution at ˜60° C. was chosen to be spun from the reservoir into a 1° C. water bath. To maintain the porosity of the sheets, the samples were frozen to −80° C. overnight and then placed in a lyophilizer for three days to ensure that the water sublimed off instead of collapsing the scaffold. Following these procedures, fiber sheets were produced having a fiber median diameter of 1.2 μm (FIG. 13E, i-iv) and a density of 0.1 g/cm³. Compared to a commercial fiber sheet, specifically TWARON, with a density of 1.4 g/cm³ and an 8 μm average fiber diameter, the produced sheets (pAFS) had a significantly smaller fiber diameter and a greater porosity as evidenced by the lower density.

Characterization of Structure and Mechanics of Resulting Para-Aramid Fiber Sheets

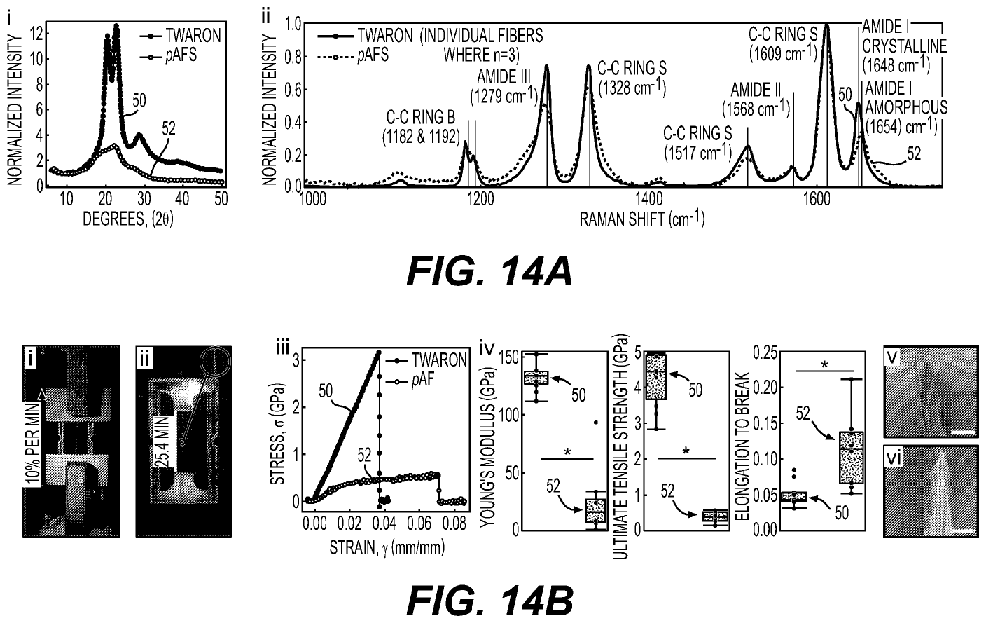

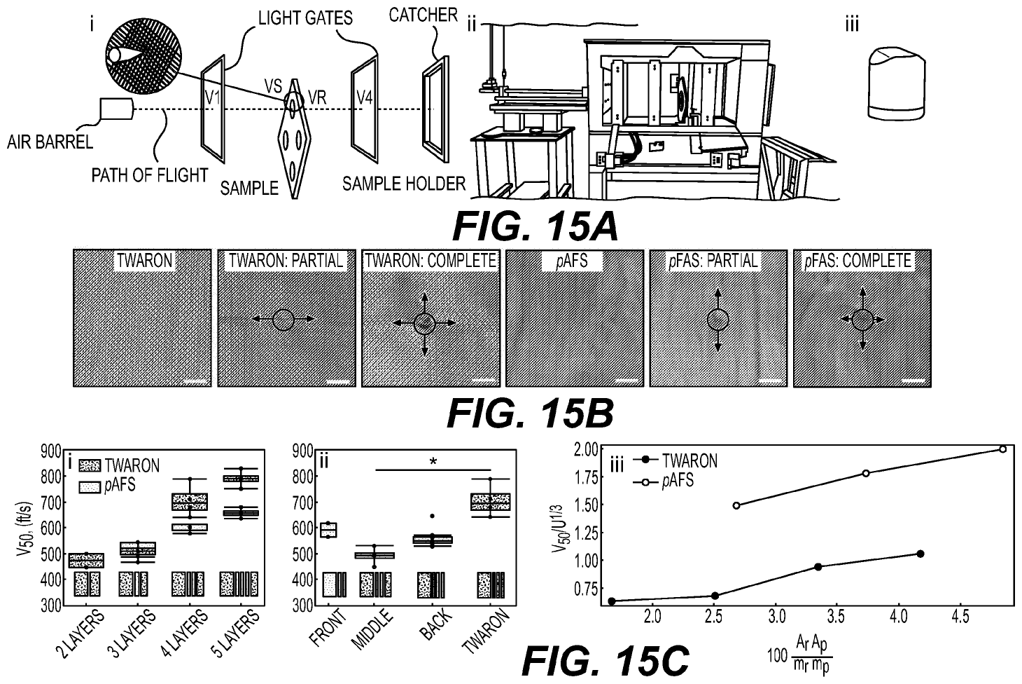

As amorphous and crystalline structures affect both mechanics and heat diffusion, X-ray diffraction was used to quantify the crystalline-amorphous ratio in both the produced sheets and in commercial fiber sheets, specifically TWARON sheets, for comparison. Examining the area of crystalline to amorphous peaks, the TWARON was determined to have a crystallinity of 80%, agreeing with published values. The produced pAFS showed significantly lower signal (FIG. 14A, graph i). As amorphous content does not provide as much X-ray signal intensity as compared to crystalline samples, the lower signal was attributed to being primarily amorphous. Based on calculations from peak measurements, the pAFS were determined to have 10% crystallinity. This low crystalline content of the pAFS as compared to that of the TWARON sheets was also confirmed by comparison of polarized Raman spectroscopy of individual produced para-aramid fibers and of individual TWARON fibers that showed the crystalline amide-II peak located at 1648 was dominant for the spectrum of the TWARON fibers as compared to the amorphous amide-II peak located at 1652 in the spectrum of the para-aramid fibers (FIG. 14A, graph ii where 50 indicates measurements corresponding to TWARON fibers and 52 indicates measurements corresponding to manufactured para-aramid fibers). The para-aramid fibers and fiber sheets low crystalline content was more closely related to that of a cast film. With this structure, the produced para-aramid fibers were predicted to have a slower time scale of heat diffusion through the fiber due to the amorphous polymer packing of the fiber, unlike the crystalline TWARON fibers, and therefore less heat conductivity through the fiber as compared with TWARON fibers.

In addition to lowering heat conduction, the amorphous content of the produced pAF increases elongation to break while lowering the strength and modulus of the pAF compared to a commercial TWARON fiber. Using uniaxial tensile testing following ASTM D3822M-14 (see FIG. 14B, images i and ii), changes in the mechanical properties of single para-aramid fibers were determined to correlate with the crystallinity differences in the fibers (see FIG. 14B, graphs iii and iv). The 160 GPa modulus of a commercial TWARON fiber was 80× greater than that of a produced para-aramid fiber and its 5 GPa strength was 10× greater than that of a produced para-aramid fiber. However, due to the amorphous content, the para-aramid fibers had a 12%, or 4x greater, elongation to break and plastic failure as compared to the commercial TWARON fibers. While the TWARON fibers failed by brittle fracture between crystallites (FIG. 14B, image v), plastic failure was observed for the para-aramid fibers (FIG. 14B, image vi).

Ballistic Performance and Fragmentation Protection

To correlate single fiber mechanical properties to the ballistic performance metric V₅₀, defined as the velocity of a projectile at which a material fails 50% of the time, the following relation was used:

$${V}_{50} ∼ {( \frac{σ ε}{2 ρ} \sqrt{\frac{E}{ρ}} )}^{1 / 3} ,$$

where σ is ultimate tensile strength, ε is elongation to break, ρ is the density, and E is the modulus of the fiber. With this relation and the experimental mechanical properties of the fibers, the ballistic performance of the TWARON fiber sheets was predicted to be only 2.76 times greater than that of the pAFS. As a result, the pAFS fiber sheets were predicted to provide slightly less fragmentation protection but increased heat protection as compared with the TWARON fiber sheets.

To verify the prediction of the mechanical testing, V₅₀ fragment simulant testing was performed to quantify the fragmentation protection of the TWARON fiber sheets and the pAFS sheets. To test the V₅₀ rating, the Combat Capabilities Development Command Soldier Center experimental setup (see FIG. 15A, schematic i and image ii) was employed to accelerate a skirted 17-grain (1.1 gram) .22 caliber fragment-simulating projectile (FSP) (see FIG. 15A, image iii) towards the material using a controllable helium gas pressure source that directly changed the resultant launching velocity. The effectiveness of the material's protection was determined by measuring the striking and residual velocity of the projectile before and after hitting the material. A registered residual velocity means a complete penetration for that striking velocity while a reading of no residual velocity means the fragment was completely stopped by the material or had too low a velocity to register. Visual inspection was used to verify if the fragment was completely stopped or was a partial penetration (see FIG. 15B). To fairly compare the unidirectionality of the non-woven pAFS versus the bi-directionality of the control commercial woven fabrics, the pAFS were sandwiched between two TWARON 750D woven piles. In addition to providing a more objective comparison, this material sandwich would more likely mimic a final layered composite product, as non-woven fibers are generally used as insulation and not as structural background for clothing. Furthermore, ballistic resistant p-aramid textiles are placed within woven sheathes in final products. As one of the goals was to reduce the need for multiple materials in providing ballistic and thermal protection, this experimental setup allowed for control of differences in the two fiber materials being evaluated. To test if the non-woven pAFS provided ballistic protection, the sheets were cross-pilled in a 0° and 90° multi-ply layups in 1, 2, or 3 layers between the woven textiles. After testing, the samples were visually inspected to confirm if there was a partial penetration or complete penetration and to see how the energy wave of the impact propagated across the sample (see FIG. 15B). Quantitatively, increasing the layers of pAFS increased the ballistic performance of the sandwich construct from 525 ft/s to 657 ft/s in V₅₀ (see FIG. 15C, graph i). While the 675 ft/s V₅₀ of the 3 layers pAFS placed between two layers of TWARON was smaller compared to 788 ft/s V₅₀ of 5 layers of TWARON at similar densities, the values were not statistically different (p≥0.151). Replacement of 1, 2, or 3 layers from a stack of TWARON with pAFS resulted in no difference in ballistic resistance.

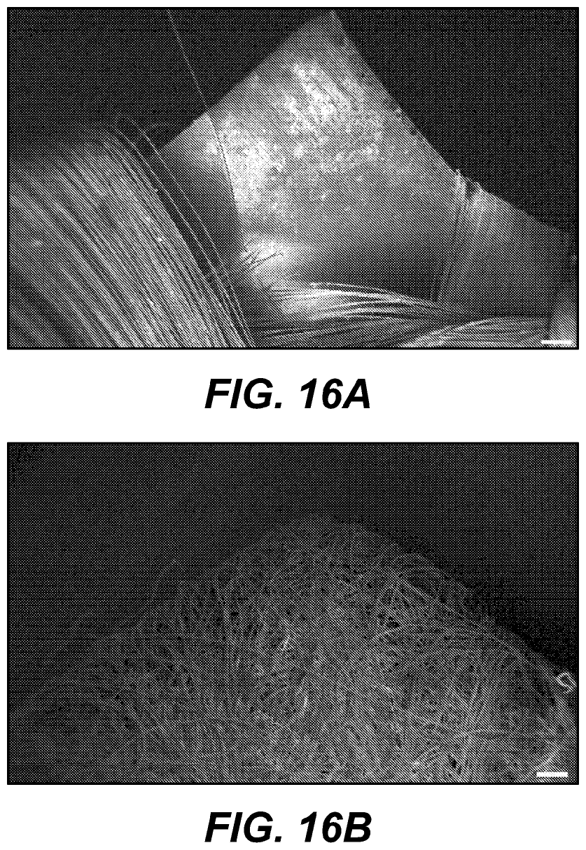

To further examine the mechanism of protection provided by the pAFS, the placement of 2 layers of pAFS was altered in relation to the 2 layers of TWARON (see FIG. 15C, ii). Depending on their position relative to the impact site, non-woven ballistic materials can provide protection by two mechanisms: 1) as the first material interacting with the projectile, they could increase the effective area of the FSP by projecting a greater area to subsequent layers, or 2) as the last layer interacting with the impact, they could act as a mechanism for energy absorption. The effect of presenting greater projectile area is greatest when the non-woven ballistic material is placed in the front, and energy absorption is most prominent when the non-woven ballistic material is placed in the rear of the construct. Testing the sheets in each of these configurations (see FIG. 15C, graph ii) showed a non-statistically significant difference to conclude by what mechanism the fiber sheets provided protection (p≥0.121). Only the pAFS layered in the middle of two TWARON sheets had a statistical difference compared to four layers of TWARON (p=0.002). The configuration of testing therefore did not impact the ballistic performance of the materials and thepAFS do not necessarily need to be in a sandwich configuration to provide ballistic protection. Overall, this experimental setup enabled control for differences in woven vs non-woven structures and enabled an understanding of the fundamental performance of the material. To normalize the V₅₀ data to its predicted ballistic performance value based on mechanical properties, the following equation was used:

$${U}^{1 / 3} ∼ \frac{σ ε}{2 ρ} \sqrt{\frac{E}{ρ}}$$

where σ is ultimate tensile strength, E is elongation to break, ρ is the density, and E is the modulus of the fiber. This normalization revealed that the pAFS and TWARON construct outperformed the predicted performance of the construct based only on fiber mechanical properties (see FIG. 15C, graph iii). The porous network therefore may be providing a means of absorbing the mechanical impact in addition to potentially providing greater puncture resistance. For example, as illustrated in the images of FIG. 16A and FIG. 16B, the weave of commercial para-aramids (FIG. 16A) allows for puncture between the individual woven pleats while the smaller fiber size and non-woven nature of the pAFS (FIG. 16B) provides greater resistance to puncture (scale bars=250 μm).

Thermal Performance

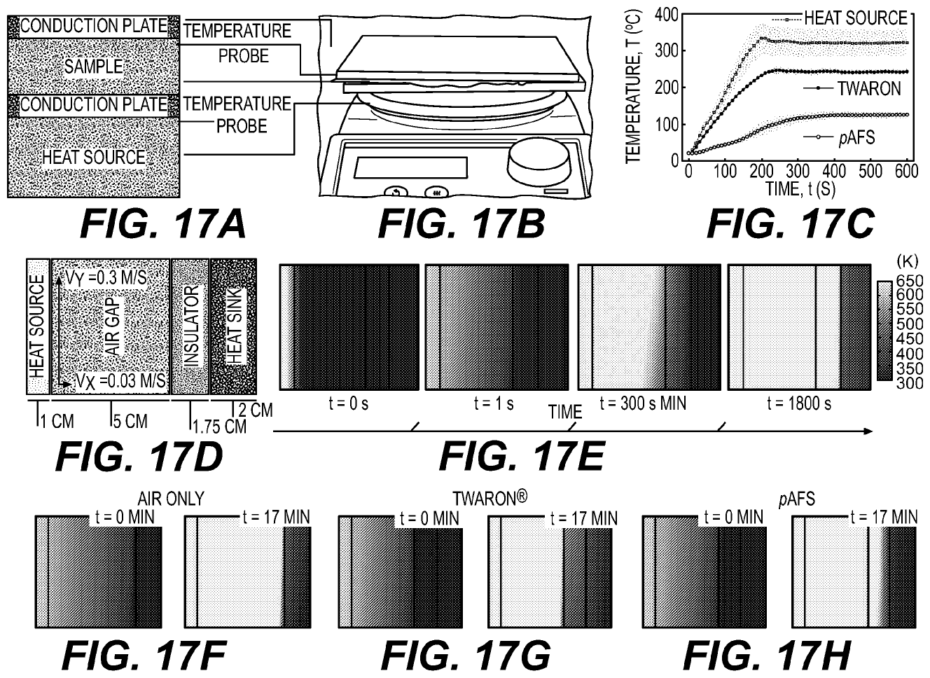

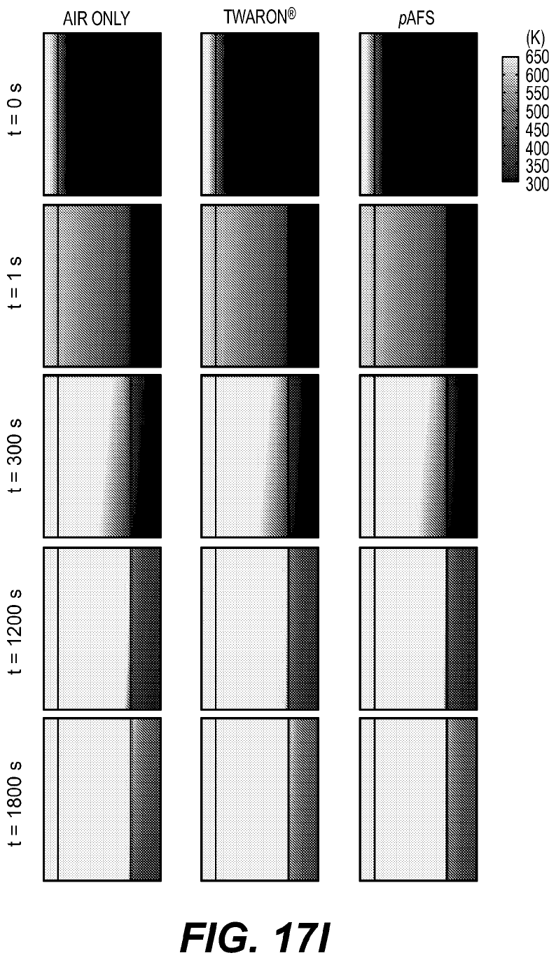

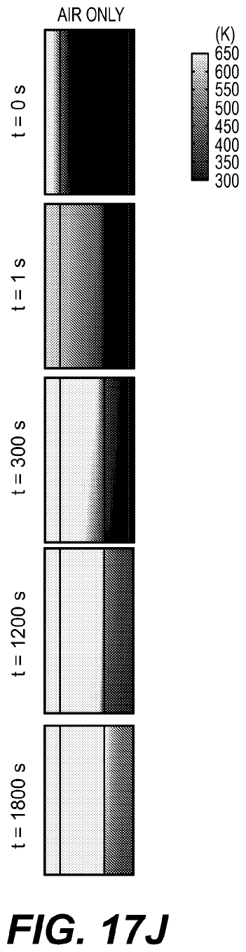

While the V₅₀ of pAFS were slightly lower compared to commercial TWARON, the pAFS had improved heat insulation. To measure the heat insulation, a 600 W heat source and probes were used to measure the temperature on both sides of one layer of the a pAFS sheet and control (see FIGS. 17A and 17B). Upon heating, the pAFSs heated more slowly than the commercial fiber sheets (FIG. 17C). Using this set-up, the heat conductivity k was determined using the following equation:

$$k = \frac{Q L}{A Δ T}$$

where A is me area of me sample, Q is the heat flux through the sample, and L is the length of the sample. The heat conductivity for the pAFS was 1.601±0.0248 W/mK (mean±standard error of the mean, n=6) perpendicular to a plane of the sheet while the commercial TWARON weaved sheets were 5.808±0.0896 W/mK (mean±standard error of the mean, n=3) resulting a statistically significant difference (p=0.024). As the pAFS created using the methods described above are less dense and thicker, this led to an insulation value, R, 20× higher than the commercial fibers as defined by

$$R = \frac{L}{k} .$$

As the materials have an inherent different structure-function relationship and resulting thickness, accounting for these differences requires simulation of heat transfer through these materials. Using material parameters based on experiments and literature, the insulation performance was simulated for the pAFS at a thickness of 1.75 cm (FIGS. 17D and 17E) and for the TWARON at a thickness of 1.75 cm (FIG. 17G) to control for thickness. To control for weight, the insulation performance was simulated for TWARON at a thickness of 0.1 cm, and for pAFS at a thickness of 0.1 cm and compared with the simulated performance for an air gap (FIG. 17I). For each thickness, thepAFS kept the heat sink at the lowest temperature at all time points (see FIGS. 17H, 17I right column), outperforming the air (see FIGS. 17F, 17I left column) and the TWARON insulating layers (see FIGS. 17G, 17I middle column). Interestingly, the TWARON insulation led to a higher temperature in the heat sink compared to an insulating layer of air due to its higher thermal conductivity under radiative heat transfer.

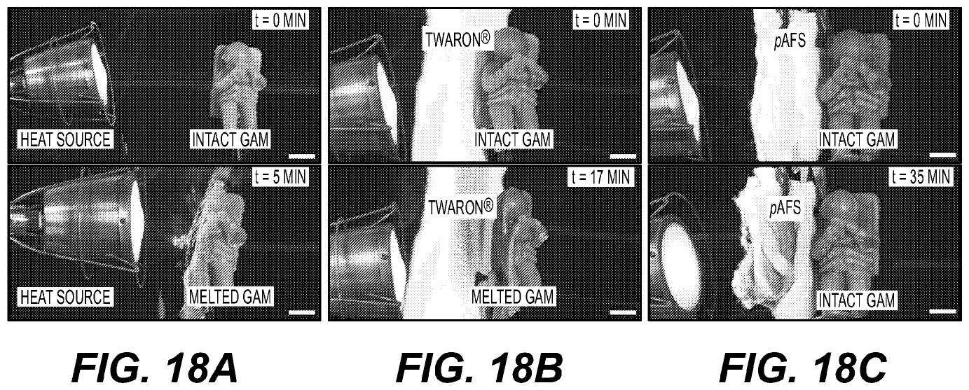

As evidence of the thermal protection of the pAFS, a blow torch with a radiative heating element attached was used melt a gelatin-astronaut figurine, also referred to herein as a gelatin astronaut model (GAM) without a protective textile covering, with a control TWARON protective covering, and with the pAFS protective covering (FIGS. 18A-18C). As air is an excellent insulator with a thermal conductivity of 0.026 W/(m² K), the blow torch was placed as close to the nearest material as possible without causing material ignition. Therefore, the torch placement without a protective layer demonstrates the heat going into the system and not as a control for the thermal insulation properties of air. To account for the difference in distance between the air and TWARON, a simulation of air only used to confirm the time scale of melting of the 3 cm air only gap experimental factor (FIG. 17J). Without any protection, the GAM melted within 5 minutes (see FIG. 18A). With the TWARON protection, the GAM melted within 17 minutes (see FIG. 18B). When exposed to heat with the pAFS protection, however, the GAM remained un-melted after 35 minutes (FIG. 18C), evidencing its ability to provide thermal protection.

The mechanical and ballistic testing and the thermal testing evidence the ability of the produced pAFS to act as multifunctional material with both fragmentation and thermal protection in extreme environments. This multifunctional benefit resulted from the construction of a multi-structured material. The long, continuous fibers with relatively high mechanical properties compared to thermally insulative fibers provided the structure to bear a mechanical load while the decreased fiber size allowed for the fibers to be free standing in a porous network, providing improved heat insulation.

Materials and Methods

Para-aramid Dope Preparation: Under mechanical stirring (300 RPM) and nitrogen environment, poly(para-phenylene terephthalamide) (PPTA) (Fibre Glast 554 KEVLAR Pulp) was dissolved in a sulfuric acid (258105-2.5 L) (H₂SO₄) solution in a 500 ml reaction vessel for 90 minutes at 85° C. Nitrogen was used to displace oxygen to reduce or prevent the sulfuric acid from degrading the polymer via oxidation. The solute and solvent were mechanically stirred with an overhead stirrer and a PTFE coated anchor impeller at 300 RPM to ensure complete dissolution. The solution was then stirred at 10 RPM for 30 minutes to degas the nitrogen from the dope to ensure nitrogen pockets did not cause a malfunction during solution extrusion.

Fiber Spinning: Fibers were fabricated using immersion Rotary Jet-Spinning (iRJS). 300 ml of polymer dope (the PPTA-H2504 solution) was extruded from a Nordson EFD syringe system (EFD 7012436) using a 22 Gauge Tapered Tip (EFD 7018298) at 20 psi into the iRJS reservoir, which is also referred to as a spinneret, spinning at 5 k RPM. The motor for the iRJS was a Nakanishi E3000 Motor (NR-3080S Spindle, EM-3080J Brushless motor, E3000 Controller, AL-C1204 Airline Kit) with a speed range from 1 k to 80 k RPM in 1 RPM increments. The spinneret/reservoir (45.4 mm diameter and two 1 mm diameter orifices) was machined from Hastelloy C276 to resist corrosion form sulfuric acid. The centrifugal force of the spinneret extruded the solution through two 1 mm orifices, through an air gap, and into a 2° C. water precipitating bath. To neutralize the added acid during spinning, 10 N Sodium Hydroxide (VWR BDH7247-4) was deposited into the bath through a syringe equipped with a conical tip (EFD 7013899, EFD 7016941, EFD 7018298) at 5 psi. The molar rate of 10 N Sodium Hydroxide deposition matched twice the molar rate of sulfuric acid. As an example, manufacturing of 5 g sheets required 500 grams of 1% solution to be spun into the bath while 1 L of 10 N NaOH was extruded into the bath for 7 minutes. The rotating collector pulled fibers in the bath to form the porous non-woven sheets. After spinning, the sheets were washed in a de-ionized water bath to remove residual salts and diffuse out any remaining acid. Sodium hydroxide was then added until all residual acid was neutralized. The fibers were then placed in a secondary de-ionized water wash bath for two hours. To dry the sheet, the fibers were frozen at −80° C. for 12 hours and then placed in a lyophilizer (SP Scientific FM35EL-85) for 48 hours at −80° C. and 10-100 mT. If dried in ambient condition, the evaporation of water would cause the fibers to collapse due to surface tension of the remaining liquid.

Scanning Electron Microscopy (SEM): SEM micrographs were obtained using a Zeiss Supra FESEM. Micrographs were gathered using a 5 kV electron source. Single fiber and sheet samples were secured using carbon tap to bind them to a SEM planchet. To minimize electron build up in the sample during testing, a 10 nm Pt/Pd coating was applied prior to imaging, using an EMS 300T D Dual Head Sputter Coater.

X-ray Diffraction: X-ray diffraction patterns were collected using a Bruker D2 phaser over double the angle of reflection (20) range of 5-90° with a scan speed of 3° min−1 and increment of 0.02°. Crystallinity was determined by measuring area of crystalline vs. amorphous peaks.

Raman Analysis: Raman spectrums were collected using a Horiba Multiline Raman Spectrometer with light polarizer, a (red) 633 nm HeNe laser, and an 1800 g/mm diffraction grating. Fibers were aligned such that samples appeared vertically in the microscope and placed on a silicon substrate. Laser power was set at 100% (17 mW) for 5 secs and averaged between two acquisitions.

Rheological Testing: Rheological properties of PPTA-H2SO4 solutions were determined using a TA Instruments Discovery Hybrid 3 Rheometer with a cone plate geometry. The cone had a 40 mm diameter, 1.988° angle, and 40 μm truncation gap. A solvent trap was employed to reduce solvent loss during testing. Due to the corrosive properties of sulfuric acid, all materials in contact with the sample were Hastelloy C276. After trimming the sample, the cone was raised and then brought back to the truncation gap, reducing normal force generated during loading. After loading, a 300 second soak time ensured the sample reached equilibrium. Steady state sensing was employed over 300 seconds of testing to ensure the sample reached equilibrium before data was recorded. If subsequent 30 second sample periods were within 5% tolerance of one another, then the sample was determined to have reached a steady state and the next point was sampled. To replicate the solution behavior on the iRJS, temperature dependent properties at 5 Hz, 83 Hz, 1% strain, were probed using a temperature ramp from −10 to 90° C. at a rate of 2.5° C. per min. Changes in truncation gap distance due to thermal expansion were calibrated before testing. Flow dependent properties were determined over a shear rate of 0.1 to 1000 l/s at 22° C. to approximate room temperature and were sampled at 10 points per decade. Strain dependent properties were determined over a strain of 10-2 to 102% and sampled at 10 points per decade at 22° C., both at 83 and 5 Hz.

Fiber Tensile Testing: Following ASTM D3822/3822-14, the two ends of a single fiber were adhered to a 150 μm thick polycarbonate frame (fabricated on a UV laser cutter) using Loctite 770 Primer and Loctite 401 adhesives. After evaporative setting for 12 hours, the frame was placed into the pneumatic grips of an Instron 5566. Before testing, the frame was cut to allow testing of the fiber only. The fiber was then pulled at a constant strain rate of 10% per min until it reached failure. After breaking, the fiber was visually inspected to ensure failure occurred in the middle of sample, validating the test methodology. If it did not break between the edges and broke at the ends where the fiber was glued to the frame, the data was not used as the fiber itself was not tested.

Fragmentation Testing: Ballistic Testing measured the strike velocity and residual velocity of a skirted 17-grain (1.1 gram), 22 caliber fragment simulating projectile (FSP) to quantify ballistic resistance of the material in terms of V₅₀. V₅₀ is the velocity required for a projectile to penetrate a material at a rate of 50% of impacts. Fragmentation testing was performed at the U.S. Army Natick Combat Capabilities Development Command Soldier Center and consisted of a Helium gas pressure system to launch the FSP, light gates to measure the V₁ and V₄ used to calculate the striking velocity (Vₛ) hitting the sample and the residual velocity (Vᵣ) leaving the sample, a material mount, and a FSP catcher. Helium gas was used as a charge with variable pressure and therefore potential energy. Upon release, the variable pressure would cause the FSP to travel at a corresponding speed. Light gates measured speed V₁ and V₄. Calibrating the system allowed for calculations of Vₛ and Vᵣ. The catcher was a metal box with one side open and filled with KEVLAR KM2 fabric. TWARON 750D was chosen as a control due to its smaller fiber size of 8 μm vs. KEVLAR KM2's 10 μm. In addition, TWARON has slightly higher mechanical properties.

Heat Insulation Testing: Heat insulation was tested using a 600 W heating source (MR Hei-Tec 505-30000-00) and temperature probes placed on both sides of the samples (Fluke High-Accuracy Thermometer Model 53-II). Changes in temperature with heat flux were used to evaluate the heat conductivity of the samples. Samples were normalized using surface area and mass, using samples that were cut to 10 cm by 10 cm in dimension, with a total mass of 5 grams.

Insulation Simulations: Insulation effectiveness of air, TWARON, and pAFS was performed in COMSOL Multiphysics 5.3 using the Heat Transfer in Porous Media Physics in a time dependent study. The heat source was modeled with a 3500 W heat rate at an initial temperature of 650 K. The air domain was modeled as an ideal gas with an air flow velocity of 0.03 m/s in x and 0.3 m/s in y with an initial temperature of 273 K. An air flow velocity was used to match the air flow conditions of the chemical hood used in the flame testing. An insulator layer of 0.1 cm or 1.75 cm thickness was modeled as an ideal gas of air, porous material of TWARON, or porous material of pAFS. Heat conductivity for TWARON and pAFS was derived during heat insulation testing. Heat capacity value of 1400 J/(kg K) based on literature was used for TWARON and pAFS. TWARON density was modeled as 480 kg/m³ and volume fraction as 0.33. pAFS density was modeled as 51 kg/m³ and volume fraction as 0.035 based on experimental measurements. The heat sink was modeled as water. Unless otherwise stated, the initial temperature of the materials was 273 K. Mesh size was set as normal and the solver was solved from 0 to 2400 s in 1 s increments.

Flame Testing: Equivalent masses of pAFS and TWARON sheets were used to determine their insulation properties. Gelatin astronaut models (GAM) were used during testing to provide a visual representation of the heat insulation capabilities of each material were created using a 3:2 (w/w) ratio of deionized water to gel strength 300 Type A porcine gelatin (Sigma Aldrich, USA), specifically 120. grams of deionized water and 80 grams of gelatin powder. After mixing, the solution was left to bloom for 10-15 minutes before being placed in an 80° C. water bath and stirred until completely dissolved. Fifteen drops of red food coloring and 1 drop of blue food coloring were then added for visual appeal. The mixture was then removed from heat, poured into a mold, and placed in a refrigerator for a minimum of 12 hours for the gelatin to set. When removed from the mold, the GAM was placed in the freezer to prevent contamination. Before insulation testing, the GAMs were thawed from the freezer. A blow torch (COLEMAN Propane Fuel Tank, Bernzomatic TS8000, SEARZALL) was then placed at a 10 cm distance from the astronaut for three trials consisting of no protection, insulation by TWARON sheets, and insulation by pAFS. When insulation was present, the sheets were positioned at a 10 cm distance between the blow torch and the GAM. The blow torch temperature 350±25° C. Flame testing occurred in a chemical hood to contain any fire outbreaks. As material can be melted away over time or the fabric layers could catch fire, the torch was manually held at this distance. Photo images were recorded every five seconds until the entire right side of the astronaut melted.

Statistical Analysis and Data Representation: To determine statistical significance, data sets were analyzed to determine if they were normally distributed. If a data set had a n>30 and skewness in the range of −0.5 to 0.5, the data set was assumed to have a normal distribution. A normally distributed group of data was then tested using a One-Way ANOVA and a Posthoc Tukey method. If data sets had a n<30 or a skewness outside the range of −0.5 to 0.5, the data set was not assumed to be normally distributed. A data set with an unknown distribution was tested using ANOVA on Ranks and a Posthoc Mann-Whitney. A p-value<0.05 was considered to be statistically significant. This procedure was performed in SigmaPlot 13. Box plots with overlaying data points were used to fairly depict data. The middle line of a box represents the median (M), the top of a box represents the 75th quartile (Q75), the bottom of a box represents the 25th quartile (Q25), the box represents the interquartile range (IQR), the top whisker represents M+1.5IQR, and the bottom whisker represents M−1.5IQR.

Approximating language, as used herein throughout the specification and claims, may be applied to modify any quantitative or qualitative representation that could permissibly vary without resulting in a change in the basic function to which it is related. Accordingly, a value modified by a term such as “about” or numerical ranges is not to be limited to a specified precise value, and may include values that differ from the specified value. In at least some instances, the approximating language may correspond to the precision of an instrument for measuring the value.

While the disclosure has been described in detail in connection with only a limited number of aspects and embodiments, it should be understood that the disclosure is not limited to such aspects. Rather, the disclosure can be modified to incorporate any number of variations, alterations, substitutions, or equivalent arrangements not heretofore described, but which are commensurate with the scope of the claims. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. A material comprising:
a plurality of poly(para-phenylene terephthalamide) (PPTA) fibers having an average fiber diameter in a range of 300 nm to 3 μm and having an average Young's modulus along a longitudinal axis of the fiber in a range of 1 GPa to 200 GPa,
the material having a thermal conductivity (k) in a range of 0.005 W/(m·K) to 10 W/(m·K) as measured perpendicular to a surface of the material and perpendicular to an orientation direction of the at least some of the plurality of fibers.

2. The material of claim 1, wherein the average Young's modulus of the plurality of PPTA fibers is a range of 1 GPa to 25 GPa; or 1.5 GPa to 5.5 GPa.

3. (canceled)

4. The material of claim 1, wherein the thermal conductivity (k) is in a range of 0.01 W/(m·K) to 10 W/(m·K); or 0.01 W/(m·K)) to 3.0 W/(m·K).

5. (canceled)

6. The material of claim 1, wherein the average fiber diameter of the plurality of PPTA fibers is in a range of 400 nm to 2.5 μm; or 400 nm to 2.0 μm or 400 nm to 1.5 μm; or 400 nm to 1.5 μm; or 400 nm to 1 μm.

7.-9. (canceled)

10. The material of claim 1, wherein the material has a volume density in a range of 0.001 g/cm³ to 0.5 g/cm³; or 0.01 g/cm³ to 0.5 g/cm³; or 0.05 g/cm³ to 0.2 g/cm³.

11. (canceled)

12. (canceled)

13. The material of claim 1, further comprising a polymer disposed between fibers in the plurality of PPTA fibers.

14. (canceled)

15. A garment comprising the material of claim 1.

16. A layered material comprising:
a first layer;
a second layer comprising the material of claim 1; and
a third layer with the second layer disposed between the first layer and the third layer.

17. (canceled)

18. (canceled)

19. A garment comprising the layered material of claim 16.

20. (canceled)

21. A method for fabricating one or more poly(para-phenylene terephthalamide) (PPTA) fibers, the method comprising:
providing a solution comprising PPTA and sulfuric acid, or comprising PPTA, dimethylsulfoxide (DSMO), and potassium hydroxide (KOH);
rotating a reservoir holding the solution about an axis of rotation to cause ejection of the solution in one or more jets from one or more orifices of the reservoir; and
collecting the one or more jets of the solution in a precipitation bath having a temperature in a range of −1° C. to 5° C. in which the PPTA in the one or more jets precipitates to form one or more PPTA fibers having a diameter or an average diameter in a range of 400 nm to 2 μm.

22. (canceled)

23. The method of claim 21, wherein a weight % of PPTA in the solution is in a range of 0.1 wt % to 2.5 wt %; or 0.3 wt % to 1.5 wt %; or 0.5 wt % to 1.0 wt %.

24. (canceled)

25. (canceled)

26. The method of claim 21, wherein the weight percentage of the sulfuric acid in the solution is in a range of 80% to 99%.

27. The method of claim 21, further comprising adding sodium hydroxide (NaOH) to the precipitation bath during collection of the one or more jets.

28.-33. (canceled)

34. A composite material comprising:
a plurality of poly(para-phenylene terephthalamide) (PPTA) fibers having an average fiber diameter in a range of 300 nm to 2 μm and each having a length to diameter aspect ratio of greater than 1000 to 1; and
a second polymer.

35. (canceled)

36. (canceled)

37. The composite material of claim 34, wherein the second polymer comprises polyurethane; or a hydrogel; or polyvinyl butyral.

38. (canceled)

39. (canceled)

40. The composite material of claim 34, further comprising phenolic resin.

41. The composite material of claim 34, wherein the plurality of PPTA fibers have an average fiber diameter in the range of 400 μm to 1.5 μm; or 400 μm to 1.0 μm.

42. (canceled)
